(19) United States
(12) Patent Application Publication
(10) Pub. No.: US 2004/0012710 A1
(43) Pub. Date: Jan. 22, 2004

(54) Optical apparatus using deformable mirror

(76) Inventors: Tsuyoshi Yaji, Kawagoe-shi (JP); Takeshi Nakane, Tokyo (JP)

Correspondence Address: PILLSBURY WINTHROP, LLP, P.O. BOX 10500, MCLEAN, VA, 22102, US

(21) Appl. No.: 10/199,505

(22) Filed: Jul. 22, 2002

(51) Int. Cl. H04N 5/235

(52) U.S. Cl. 348/362

(57) ABSTRACT

An optical apparatus using a deformable mirror includes an imaging device for obtaining an image signal from an image formed through a photographic lens, an exposure control device for making control containing driving control of the imaging device, a deformable mirror having a reflecting surface deformed by an electric force and electrodes controlling the profile of the reflecting surface, a power supply device for supplying power to drive the deformable mirror, a driving device for driving the deformable mirror, and a device for driving the photographic lens. In this case, when the photographic lens is driven or exposure is controlled by the exposure control device, the deformable mirror is not driven by the driving device.

### BACKGROUND OF THE INVENTION

1. Field of the Invention

The present invention relates to an optical apparatus, such as a camera, using a deformable mirror.

2. Description of Related Art

In recent years, a deformable mirror applicable to a small-sized apparatus has been proposed in which a semiconductor process is used and the reflecting surface of the mirror can be deformed, for example, by the force of electricity such as static electricity to bring about a desired optical characteristic. When this deformable mirror is used, there is the possibility that an apparatus utilizing the features of the deformable mirror, such as compactness due to space saving, a simple structure, and a high-speed response, can be provided.

However, a high voltage is required for the driving control of the deformable mirror, and thus when the deformable mirror is used for an optical member, such as an AF (autofocus) component, constituting an apparatus, for example, a camera driven by a battery, power consumption is so large that it cannot be neglected.

Therefore, for example, when operations of large power consumption attributable to lens driving and exposure control are performed and at the same time, the deformable mirror is driven, the problem arises that the overall power load becomes extremely heavy, and the operation of the deformable mirror cannot be assured in the worst case.

In addition, a case occurs in which optical performance cannot be set with a high degree of accuracy, as designed, due to the assembly error of the deformable mirror itself. Conversely, to eliminate the error, the accuracy of components and assembly of the deformable mirror is required and cost is increased. This is unsuitable for an inexpensive apparatus.

Where the deformable mirror is incorporated in a photographing optical system of a camera, normal optical performance may not be immediately obtained, for example, when photographing is performed after the camera is left for a long period of time or when an image is observed after the deformable mirror is driven.

Furthermore, in the case of an exposure operation in which the accuracy of the deformable mirror is required or a long-time exposure operation in which the same position is held for a long period of time, the optical characteristic of the reflecting surface is changed when a voltage change by a leakage current is brought about, and the accuracy of the image is adversely affected so that it cannot be maintained.

### SUMMARY OF THE INVENTION

It is, therefore, a primary object of the present invention to provide an optical apparatus using a deformable mirror in which a burden to a power source system is lessened and the operation of the deformable mirror can be stabilized.

It is another object of the present invention to provide a driving device of the deformable mirror in which the optical performance of the deformable mirror, not affected by the accuracy of components and assembly of the deformable mirror and photographing conditions, can be maintained with a high degree of accuracy, and which is applicable to an inexpensive optical apparatus.

In order to achieve the above objects, the optical apparatus using the deformable mirror according to the present invention includes an imaging means for obtaining an image signal from an image formed through a photographic lens, an exposure control means for making control containing driving control of the imaging means, a deformable mirror having a reflecting surface deformed by an electric force and electrodes controlling the profile of the reflecting surface, a power supply means for supplying power to drive the deformable mirror, a driving means for driving the deformable mirror, and a means for driving the photographic lens. In this case, when the photographic lens is driven or exposure is controlled by the exposure control means, the deformable mirror is not driven by the driving means.

The optical apparatus using the deformable mirror according to the present invention, preferably, further includes a stroboscope control means for controlling the charge and discharge of a stroboscope illuminating an object. When the charge and discharge of the stroboscope is controlled, the deformable mirror is not driven by the driving means.

The optical apparatus using the deformable mirror according to the present invention, preferably, further includes a recording means for recording data according to an image signal obtained by the imaging means. When the data are recorded by the recording means, the deformable mirror is not driven by the driving means.

The optical apparatus using the deformable mirror according to the present invention, preferably, further includes a mode setting means for setting a plurality of modes containing a photographic mode. When a mode other than the photographic mode is set by the mode setting means, the deformable mirror is not driven by the driving means.

The driving device of the deformable mirror according to the present invention includes a deformable mirror having a reflecting surface deformed by electrostatic attraction and electrodes controlling the profile of the reflecting surface, a driving means for driving the deformable mirror, a memory means for prestoring data according to a change of the profile of the reflecting surface, and a correcting means for correcting a driving condition of the driving means in accordance with the data stored in the memory means.

The driving device of the deformable mirror according to the present invention is such that the memory means stores data for obtaining a desired profile of the reflecting surface in an initial state through the driving means.

The driving device of the deformable mirror according to the present invention is such that the driving means drives the electrodes into an initial state in accordance with the data stored in the memory means when a power source is turned on or before photographing.

These and other objects as well as the features and advantages of the present invention will become apparent from the following detailed description of the preferred embodiments when taken in conjunction with the accompanying drawings.

### BRIEF DESCRIPTION OF THE DRAWINGS

FIG. 1 is a diagram showing schematically a systematic construction of a camera using a deformable mirror of one embodiment of the present invention;

FIG. 2 is a block diagram showing the arrangement of electrodes constituting the deformable mirror used in the camera and a power circuit for voltage control, in the embodiment;

FIG. 3 is a timing chart where a plurality of electrodes are driven in the deformable mirror used in the camera of the embodiment;

FIGS. 4A, 4B, 4C, 4D, and 4E are side views showing deformed states of the upper electrode of FIG. 2 in the deformable mirror used in the camera of the embodiment;

FIGS. 4F and 4G are plan views showing the arrangement of the lower electrodes of FIG. 2;

FIG. 5 is an explanatory view showing an example where the deformable mirror is used in a range measurement section in the camera of the embodiment;

FIG. 6 is a flowchart showing driving control on photographing in the camera using the deformable mirror of the embodiment;

FIG. 7 is a flowchart showing a range measurement process in the camera using the deformable mirror of the embodiment;

FIG. 8 is a view showing schematically one example where the deformable mirror is used in an imaging section in the camera of the embodiment;

FIG. 9 is a view showing schematically another example where the deformable mirror is used in an imaging section in the camera of the embodiment;

FIG. 10 is a conceptual view showing a memory data construction in EEPROM which is an essential part of the driving device of the deformable mirror of the embodiment;

FIG. 11 is a flowchart showing driving control on photographing in the camera provided with the driving device of the deformable mirror of the embodiment;

FIG. 12 is a flowchart showing the range measurement process in the camera provided with the driving device of the deformable mirror of the embodiment;

FIG. 13 is a flowchart of a zoom process in the camera provided with the driving device of the deformable mirror of the embodiment;

FIG. 14 is a block diagram showing a circuit configuration for monitoring voltages flowing through electrodes in the arrangement of the electrodes and the power circuit for voltage control, constituting the deformable mirror used in the camera of the embodiment;

FIG. 15 is a view showing schematically a Keplerian finder for a digital camera using an optical-property mirror in another embodiment of the camera of the present invention;

FIG. 16 is a view showing schematically another embodiment of the deformable mirror applicable to the camera of the present invention;

FIG. 17 is an explanatory view showing one aspect of electrodes used in the deformable mirror of the embodiment of FIG. 16;

FIG. 18 is an explanatory view showing another aspect of electrodes used in the deformable mirror of FIG. 16;

FIG. 19 is a view showing schematically another embodiment of the deformable mirror applicable to the camera of the present invention;

FIG. 20 is a view showing schematically another embodiment of the deformable mirror applicable to the camera of the present invention;

FIG. 21 is a view showing schematically another embodiment of the deformable mirror applicable to the camera of the present invention;

FIG. 22 is an explanatory view showing the winding density of a thin-film coil in the deformable mirror of FIG. 21;

FIG. 23 is a view showing schematically another embodiment of the deformable mirror applicable to the camera of the present invention;

FIG. 24 is an explanatory view showing an example of an array of coils in the deformable mirror of FIG. 23;

FIG. 25 is an explanatory view showing another example of the array of coils in the deformable mirror of FIG. 23;

FIG. 26 is an explanatory view showing an array of permanent magnets suitable for the array of coils of FIG. 25 in the embodiment of FIG. 21;

FIG. 27 is a view showing schematically an imaging system using the deformable mirror applicable to the camera in another embodiment of the present invention;

FIG. 28 is a view showing schematically another embodiment of the deformable mirror applicable to the camera of the present invention;

FIG. 29 is a view showing schematically an example of a micropump applicable to the camera of the present invention;

FIG. 30 is a view showing the principle of a variable focal-length lens applicable to the camera of the present invention;

FIG. 31 is a view showing the index ellipsoid of a nematic liquid crystal molecule of uniaxial anisotropy;

FIG. 32 is a view showing a state where an electric field is applied to the macromolecular dispersed liquid crystal layer of the variable focal-length lens in FIG. 30;

FIG. 33 is a view showing one example where a voltage applied to the macromolecular dispersed liquid crystal layer in FIG. 30 can be changed;

FIG. 34 is a view showing one example of an imaging optical system for digital cameras which uses the variable focal-length lens applicable to the camera of the present invention;

FIG. 35 is a view showing one example of a variable focal-length diffraction optical element applicable to the camera of the present invention;

FIG. 36 is a view showing variable focal-length spectacles, each having a variable focal-length lens which uses a twisted nematic liquid crystal;

FIG. 37 is a view showing the orientation of liquid crystal molecules where a voltage applied to a twisted nematic liquid crystal layer of FIG. 36 is increased:

FIGS. 38A and 38B are views showing two examples of variable deflection-angle prisms, each of which is applicable to the camera of the present invention;

FIG. 39 is a view for explaining the applications of the variable deflection-angle prisms shown in FIGS. 38A and 38B;

FIG. 40 is a view showing one example of a variable focal-length mirror as the variable focal-length lens applicable to the camera of the present invention;

FIG. 41 is a view showing schematically an imaging unit using the variable focal-length lens, in another embodiment, applicable to the camera of the present invention;

FIG. 42 is an explanatory view showing a modified example of the variable focal-length lens of FIG. 41;

FIG. 43 is an explanatory view showing a state where the variable focal-length lens of FIG. 42 is deformed;

FIG. 44 is a view showing schematically another embodiment of the variable focal-length lens applicable to the camera of the present invention;

FIG. 45 is a view showing schematically the variable focal-length lens using a piezoelectric substance, applicable to the camera of the present invention;

FIG. 46 is an explanatory view showing a state where the variable focal-length lens of FIG. 45 is deformed;

FIG. 47 is a view showing schematically the variable focal-length lens using two thin plates made with piezoelectric substances, in still another embodiment, applicable to the camera of the present invention;

FIG. 48 is a view showing schematically another embodiment of the variable focal-length lens applicable to the camera of the present invention;

FIG. 49 is an explanatory view showing the deformation of the variable focal-length lens of FIG. 48;

FIG. 50 is a view showing schematically the variable focal-length lens using a photonical effect, in a further embodiment, applicable to the camera of the present invention;

FIGS. 51A and 51B are explanatory views showing the structures of azobenzene of trans- and cis-type, respectively, used in the variable focal-length lens of FIG. 50;

FIG. 52 is an explanatory view showing one example of division of a transparent electrode used in the variable focal-length lens applicable to the camera of the present invention;

FIG. 53 is an explanatory view showing another example of division of a transparent electrode used in the variable focal-length lens applicable to the camera of the present invention;

FIG. 54 is an explanatory view showing still another example of division of a transparent electrode used in the variable focal-length lens applicable to the camera of the present invention; and

FIG. 55 is an explanatory view showing a further example of division of a transparent electrode used in the variable focal-length lens applicable to the camera of the present invention.

### DETAILED DESCRIPTION OF THE PREFERRED EMBODIMENTS

In accordance with the drawings, the embodiments of the present invention will be described below.

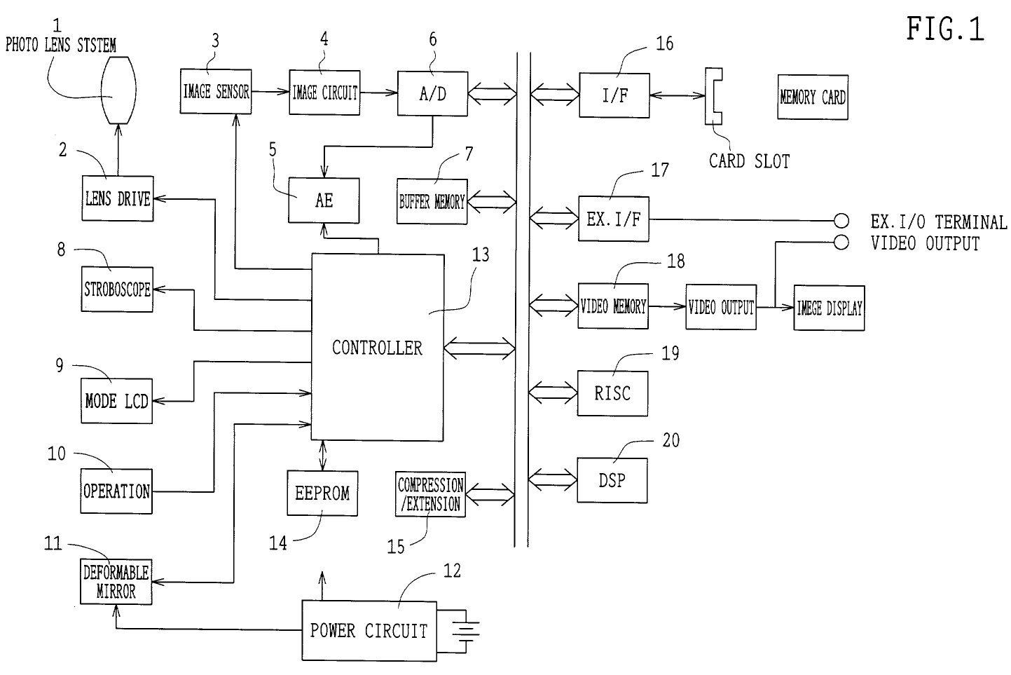

FIG. 1 shows a systematic construction of a camera using a deformable mirror of one embodiment of the present invention. The camera provided with the deformable mirror of the present invention includes a photographic lens system 1 having a stop and a mechanical shutter which are not shown; a lens drive 2 having a motor and a motor driver for adjusting the focal position of the photographic lens system 1; an image sensor 3 such as a CCD image sensor; an imaging circuit 4 for driving the image sensor 3 to transmit an image signal; an A/D converter 6 for converting an analog image signal into a digital image signal; a buffer memory 7 for temporarily storing the image signal; a stroboscopic light-emitting circuit 8; a DSP (digital signal processor) 20 for image processing; an RISC-microprocessor 19; a data compression/extension circuit 15; an I/F (interface) 16 for accessing a removable memory card mounted to a card slot; a video memory 18 storing image data for image-displaying the digital image signal and outputting a video signal from a video output terminal; and an I/F 17 for performing a data input/output operation with respect to external devices through external input/output terminals. The camera further includes an AE section 5 for determining the exposure of the image sensor 3 on photographing; a mode LCD 9 for displaying photographic information such as an operation mode; a control section 10 for performing operations, such as photography and reproduction; a deformable mirror 11; and a power circuit 12 for supplying the power to individual sections of the camera and the deformable mirror 11. In addition, the camera has a system controller 13 for making control of individual sections involved in the operations such as photography of the camera and reproduction. The control section 10 is provided with a release button and a mode setting control portion, which are not shown, indicating the start and record of photography.

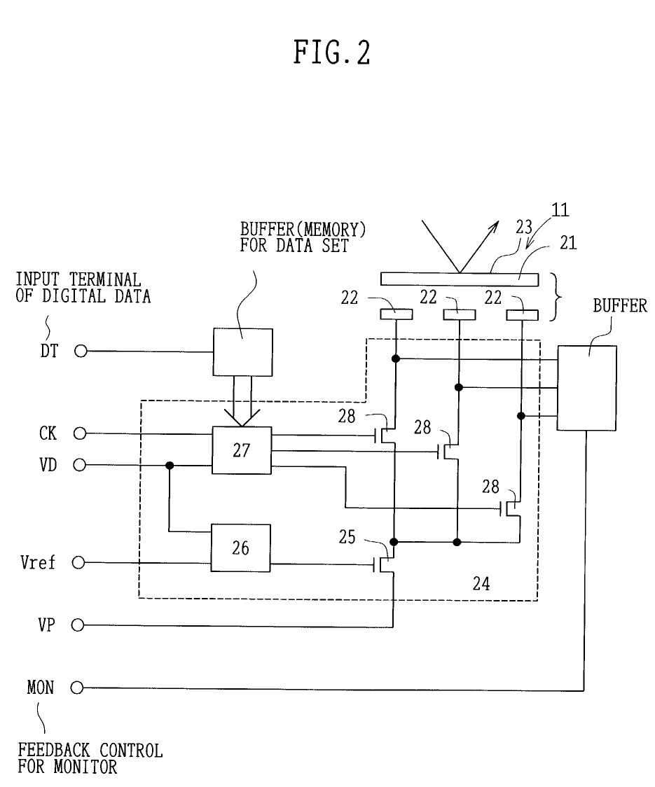

FIG. 2 shows the arrangement of electrodes constituting the deformable mirror 11 used in the camera and a power circuit for voltage control, in the above embodiment. The deformable mirror 11 has a flexible thin film provided with a reflecting surface 23 and an upper electrode 21 and a control substrate comprised of lower electrodes 22 which are control electrodes arranged opposite to the electrode 21 and a control circuit. This control substrate is connected to the power circuit 12 and the system controller 13 in FIG. 1.

In FIG. 2, a high-voltage power VP is a constant-voltage power of about 100 V, and a reference voltage Vref is a variable voltage of about 5 V. A driving voltage VD is a voltage power for driving a voltage control circuit 24. The high-voltage power VP, the reference voltage Vref, and the driving voltage VD are applied and supplied to the voltage control circuit 24. The voltage control circuit 24 is provided with a high-resistance voltage control transistor 25 and a control circuit 26. The high-voltage power VP is controlled so that it becomes an output voltage corresponding to the reference voltage Vref of low voltage through the voltage control circuit 24, and is applied to the lower electrodes 22 of control electrodes. A clock input terminal CK is adapted to emit a timing pulse which is a pulse voltage synchronized with a change of the reference voltage Vref. In addition to the high-resistance voltage control transistor 25 and the control circuit 26, the voltage control circuit 24 is provided with a timing generating circuit 27 and high-resistance switching transistors 28.

The power circuit has a data input terminal DT and a data storing buffer. From the data storing buffer in which a driving voltage value correcting the error of the deformable mirror is stored through the data input terminal DT in accordance with the photographing condition, a corrected driving voltage value corresponding to a data input value is fed to the control circuit 26 so that the reference voltage can be corrected by the corrected driving voltage value.

In the deformable mirror (including the voltage control circuit) constructed as mentioned above, the reference voltage Vref, which corresponds to a voltage applied to a given electrode of the lower electrodes 22 of divided control electrodes, is inputted, and an output voltage is controlled by the voltage control transistor 25 and the control circuit 26. In synchronization with this, the timing pulse is inputted and the switching transistor 28 corresponding to a corresponding control electrode is brought into an on state by the output of the timing generating circuit 27. After a certain time is passed, the corresponding switching transistor 28 is brought into an off state, and the output of the voltage control transistor 25 is disconnected from the control electrode to constantly maintain the voltage applied to the control electrode. Whereby, a controlled voltage is applied to the corresponding control electrode. The voltage control by the reference voltage and the on-off operation of the switching transistor 28 by the timing pulse are performed in time series, and thereby a given voltage can be applied to each of the divided control electrodes.

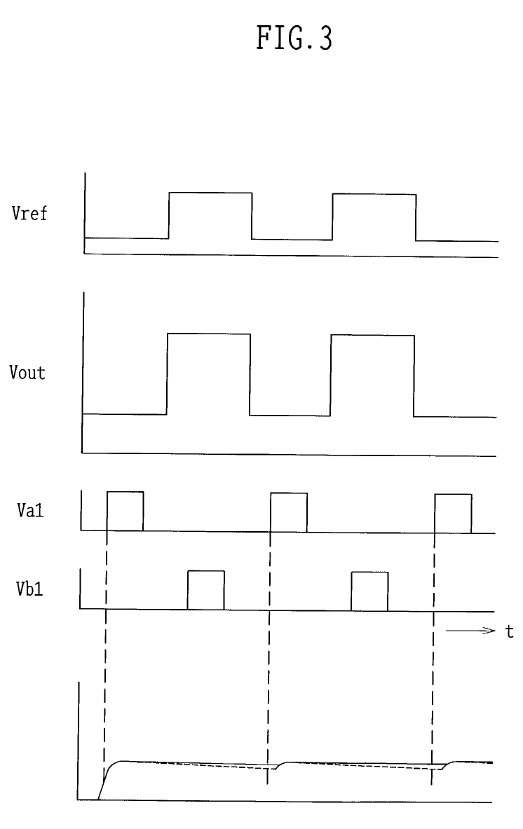

Also, the timing chart of the voltage control circuit in this case is shown in FIG. 3. In this figure, two of the divided electrodes are arbitrarily given.

Here, in the deformable mirror, a load component corresponds to a capacitance component by the opposite electrode, and a voltage applied to the opposed electrode is a direct-current voltage. Hence, even when the applied voltages of the divided control electrodes are controlled in time series, the voltages applied to individual electrodes can be kept constantly in great ease. These circuits are unified, and thereby the deformable mirror having a plurality of divided control electrodes can be driven by merely supplying the power and the control signal from the exterior. Moreover, even though the number of divided control electrodes is increased, there is no need to increase the number of control circuits accordingly, and the voltage control can be made by a simple change of the timing generating circuit and an increase of the switching transistor. Consequently, space saving is afforded and a deformable mirror suitable for compact design can be provided.

Also, in FIG. 2, the upper electrode 21 is constructed as a single electrode and the lower electrodes 22 are constructed as a plurality of electrodes. In contrast to this, however, the deformable mirror may be designed so that the upper electrode 21 is divided into a plurality of electrodes, which are connected to the circuits such as those shown in FIG. 2, and the lower electrodes 22 are constructed as a single electrode, which has the reflecting surface 23.

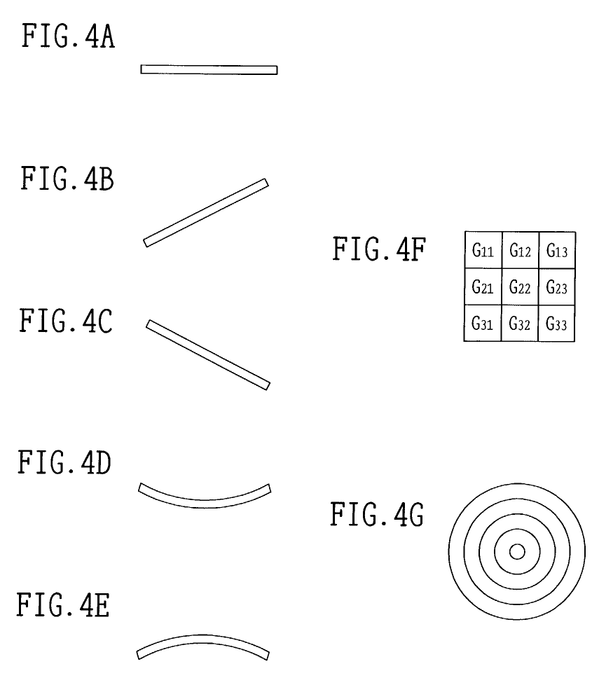

FIGS. 4A-4G show the electrodes of the deformable mirror used in the camera of the embodiment. FIGS. 4A-4E illustrate deformed states of the upper electrode 21 in FIG. 2, and FIGS. 4F and 4G illustrate arrangements of the lower electrodes 22 in FIG. 2.

The plurality of lower electrodes 22 of the deformable mirror, as shown in FIG. 4F, may be arrayed like checkers according to the deformed state, or as shown in FIG. 4G, may be concentrically arrayed.

The upper electrode 21, as shown FIG. 4A, may be driven so that the whole is pulled parallel to the opposed electrodes, or as shown in FIGS. 4B and 4C, may be drived so that its one side is pulled toward the opposed electrodes. Alternatively, as shown in FIGS. 4D and 4E, it may be deformed to be concave or convex with respect to the opposed electrodes.

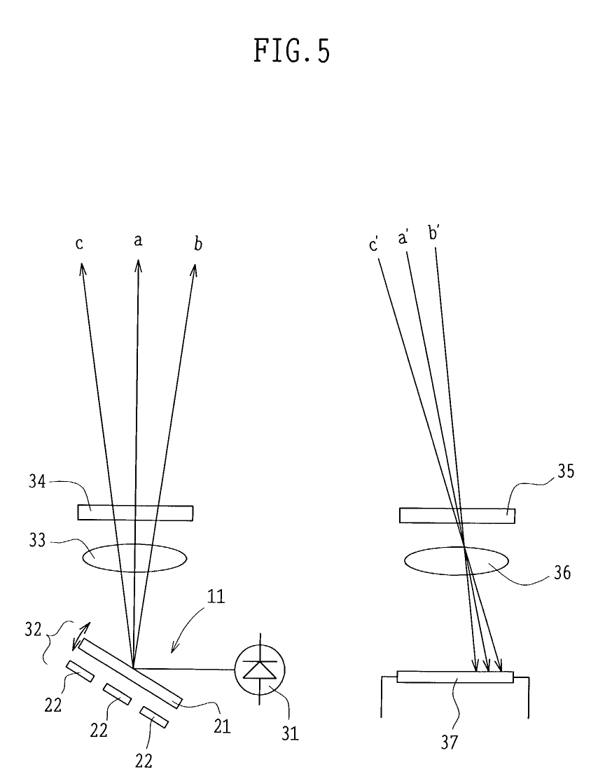

FIG. 5 shows an example where the deformable mirror is used in a range measurement section in the camera of the embodiment. The range measurement section is constructed so that, on the principle of triangulation, light transmitted through a lens separated by a predetermined base length is detected by a housed sensor, and thereby a signal corresponding to an object distance can be detected.

More specifically, infrared light from an infrared (IR) light-emitting diode 31 is reflected by a reflecting surface 32 of the deformable mirror 11 to radiate an object (which is omitted from the figure because it is located on extension lines of arrows a, b, and c) through a projection lens 33 and a projection window 34. Subsequently, light (indicated by arrows a′, b′, and c′) reflected from the object and passing through a light-receiving window 35 and a light-receiving lens 36 is received by a light receiver 37, such as a PSD, so that the object distance is detected by its output. In this case, the lower electrodes 22 of the deformable mirror 11 are controlled and driven so that light is projected by the reflecting surface 32 in the directions of the arrows a, b, and c. Also, in FIG. 5, a case where the object to be measured is scanned on the plane of the paper in a lateral direction is shown, but it is, of course, possible to scan the object in another direction. Thus, by using the deformable mirror, the object to be measured is scanned on a photographic image plane and the focal length can be measures at any place.

When such a deformable mirror is driven, the high voltage is required as mentioned above, and hence there is the fear that if another operation of large power consumption is performed at the same time, the load of the power source will be increased and the operation of the driving control becomes unstable. In the camera using the deformable mirror in the embodiment, therefore, drive timing is controlled so that such an operation of large power consumption is not performed at the same time.

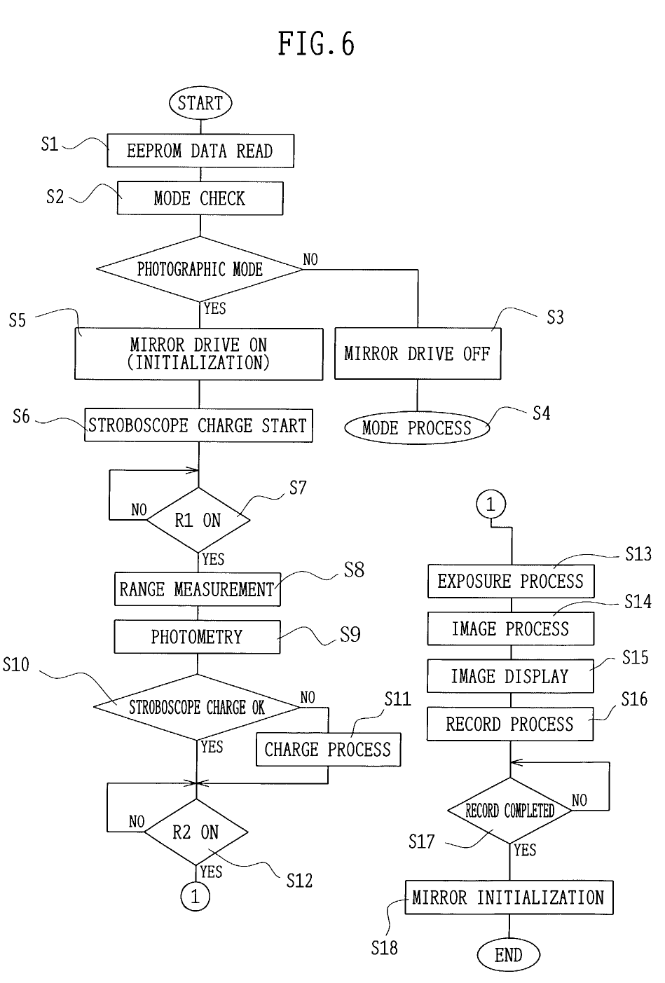

FIG. 6 is the flowchart showing the driving control on photographing in the camera using the deformable mirror of the embodiment. In FIG. 6, various data stored in an EEPROM 14 of the camera are first read out (Step S1). Subsequently, a mode selecting image is displayed, for example, on the mode LCD 9 of the camera in FIG. 1, and a photographer makes a mode selection. The mode selected by the photographer is checked (Step S2).

When a photographic mode is not selected, the power source of the drive of the deformable mirror, such as a driving power, of power sources from the power circuit 12 of FIG. 1 is turned off so that the power is not supplied to the voltage control circuit 24 of FIG. 2 (Step S3), and various modes selected thereafter are processed (Step S4). Also, for the mode selection, there are a photographic mode, a reproducing mode for photographic images, a setting mode for various numerical values, and an exterior communication mode. For convenience of description, however, reference is here made to the case where the photographic mode is selected.

When the photographic mode is selected, the power source of the drive of the deformable mirror is turned on, and the orientation and deformed state of the reflecting surface 23 are brought into the initial state, by preset voltage values previously read out from the EEPROM 14, with respect to the electrodes 22 of FIG. 2 constituting the deformable mirror. The power source is then turned off (Step S5).

After that, a stroboscope charge process is started (Step S6). Whether a release button is half-pushed is checked, and this procedure is repeated until the release button is half-pushed (Step S7). When the release button is half-pushed, the range measurement process is executed (Step S8).

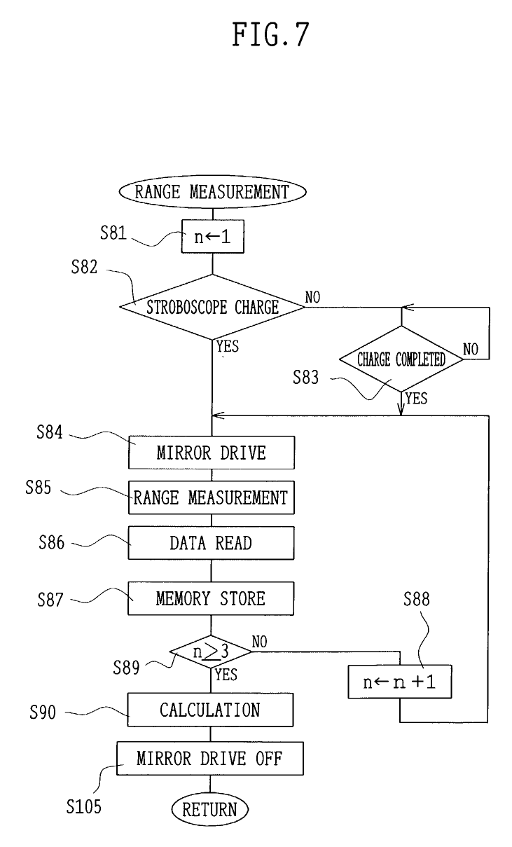

FIG. 7 is the flowchart of the range measurement process in the camera using the deformable mirror of the embodiment. In the range measurement process, 1 is set to a measuring position counter n as an initial process (Step S81). Next, whether a stroboscope is charged is checked (Step S82), and when it is charged, the process is placed in a wait state until the charge is completed (Step S83).

When the charge of the stroboscope is not completed or a stroboscope charge operation is not performed, the power source of the drive of the deformable mirror is turned on to supply the power to the voltage control circuit 24, and the electrodes 22 are driven to change the profile of the reflecting surface 23 so that the distance of a position corresponding to the measuring position counter n (for example, the position of one of the arrows a, b, and c in FIG. 5) can be measured (Step S84). The distance of the object to be measured at this position is measured (Step S85). A measured value according to the output signal of the light receiver 37 of FIG. 5 is read out (Step S86) and is temporarily stored in the buffer memory 7 of FIG. 1 (Step S87).

After that, 1 is added to the measuring position counter n (Step S88), and until the range measurement of the entire area of the photographic image relative to the object to be measured is completed (until the counter n reaches 3 in the figure), the range measurements at the corresponding positions are made and procedure that each of measured values thus obtained is stored in the buffer memory 7 is repeated (Step S89). The area of the photographic image may be scanned two-dimensionally.

Of the positions of the arrows a, b, and c, the position of the arrow a may be thought of as the position of the initial state. In this case, it is only necessary to measure the displacement of the remaining positions of the arrows b and c, and thus the number of position settings can be decreased.

Subsequently, the amount of drive of a predetermined lens constituting the photographic lens system 1 of FIG. 1 to be driven is calculated from the above measured values so that the object located at a desired position is imaged on the image sensor through the photographic lens system 1 (Step S90), and then the power source of the drive of the deformable mirror 11 is turned off (Step S1105). In this way, the range measurement process (Step S8) is completed.

In the check of the stroboscope charge, when the stroboscope is charged, the procedure may be varied so that the charge of the stroboscope is stopped temporarily for the priority of processing after the driving of the deformable mirror; after the profile of the reflecting surface 23 is changed, the range measurement at the corresponding position is made; the measured value thus available is stored in the buffer memory; the amount of drive of a predetermined lens constituting the photographic lens system 1 is calculated from the measured value (Step S84-Step S89); and after the power source of the drive of the deformable mirror is turned off (Step S105), the charge of the stroboscope is started again.

After the range measurement process (Step S8) is completed, as shown in FIG. 6, a photometric process (Step S9) is performed. Then, in the case of stroboscopic photography, whether the stroboscope is charged is checked (Step S10), and when it is charged, the process is placed in the wait state until the charge is completed (Step S11). When the charge of the stroboscope is completed or has been completed, the process is placed in the wait state until the release button is fully pushed (Step S12). During this process, by a calculated value obtained from the range measurement process, the lens drive 2 in FIG. 1 drives the photographic lens system 1 so that the object located at a desired position is imaged on the image sensor 3 through the photographic lens system 1. In addition to the driving mentioned above, the lens drive 2 carries out the driving for changing the magnification of the photographic lens system 1 and the driving of lenses constituting the photographic lens system 1, from a collapsible position to a photographic position.

When the release button is fully pushed, an exposure process is executed (Step S13). In the exposure process, the driving of the mechanical shutter, the control of the image sensor 3, and the exposure operation such as stroboscopic light-emission are performed on the basis of the aperture of the stop and a shutter speed which are determined in accordance with values obtained by the photometric process, and an image process is executed on the basis of an image signal obtained (Step S14). After that, a photographed image is displayed (Step S15) and is recorded in a recording medium, such as a memory card, by the operation of the photographer as occasion demands (Step S16).

During this operation, the power source of the drive of the deformable mirror 11 is held in an off state. After the record of image information is completed (Step S17), the power source of the drive of the deformable mirror 11 is turned on, and the orientation and deformed state of the reflecting surface is initialized by the electrodes constituting the deformable mirror 11 (Step S18). The power source of the drive of the deformable mirror 11 is then turned off and the photographic process of one frame is completed.

According to the camera using the deformable mirror of the embodiment, as mentioned above, the supply of the power to the deformable mirror and the driving of the deformable mirror are not executed during the lens driving and the exposure operation, and thus the burden to the power source system is lessened and the operation of the deformable mirror can be stabilized.

Since the supply of the power to the deformable mirror and the driving of the deformable mirror are not executed during the stroboscope charge, the burden to the power source is lessened even when the stroboscope is used.

Further, since the supply of the power to the deformable mirror and the driving of the deformable mirror are not executed during the record of imaging data, the recording operation of the data is not adversely affected.

Still further, since the supply of the power to the deformable mirror and the driving of the deformable mirror are not executed in the processes except for the photometric mode, the power can be saves accordingly.

In addition to the structure that the deformable mirror is provided in the range measurement section as in the embodiment of FIG. 5, the camera using the deformable mirror of the present invention is applicable to the structure that the deformable mirror is used in an imaging section.

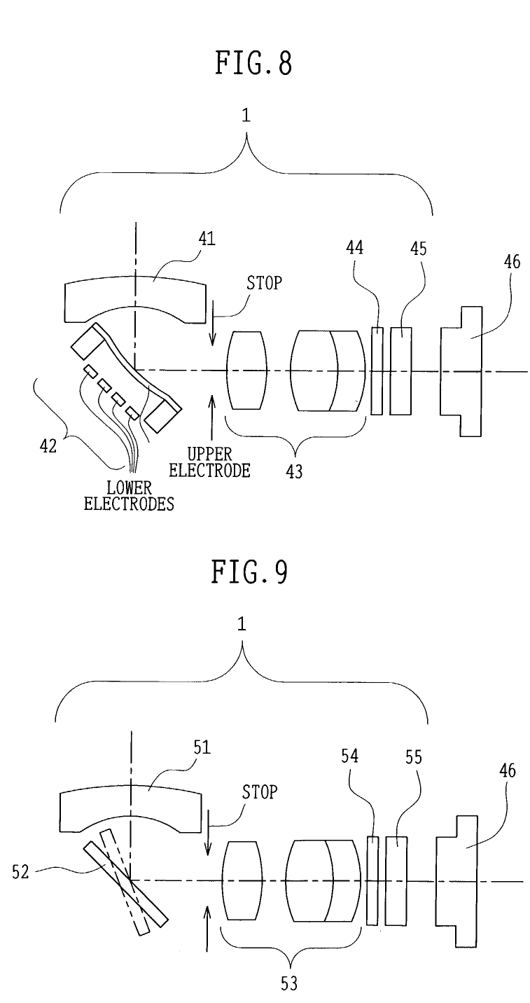

FIGS. 8 and 9 show examples where the deformable mirror is used in the imaging section in the camera of the embodiment. In FIG. 8, the photographic lens system 1, situated before an image sensor 46, includes a lens 41, a deformable mirror 42, a lens unit 43, an infrared cutoff filter 44, and a low-pass filter 45. The voltage according to the object distance obtained through the range measurement section is applied to the electrodes of the deformable mirror 42 to deform the reflecting surface of the deformable mirror 42 into a concave shape. Whereby, the power of the reflecting surface is changed to vary the focal length of the imaging system, so that an autofocus operation can be performed.

In FIG. 9, the photographic lens system 1, located before the image sensor 46, includes a lens 51, a variable-tilting deformable mirror 52, a lens unit 53, an infrared cutoff filter 54, and a low-pass filter 55. In accordance with the amount of hand shake obtained through two angular speed sensors for detecting angular speeds in yaw and pitch directions, the voltage is applied to the electrodes of the variable-tilting deformable mirror 52, and the amount of hand shake can be corrected by tilting the reflecting surface of the variable-tilting deformable mirror 52.

By doing so, the photographic lens unit 1 can be adjusted to a desired focal point without moving the lens unit 43 or 53 constituting the photographic lens unit 1. As such, lens driving members can be eliminated accordingly and the structure of the photographic lens can be simplified.

In the case where the deformable mirror is used in the imaging section as in FIGS. 8 and 9, the control of the driving power section of the deformable mirror is substantially the same as the case where it is used in the range measurement section, and it is only necessary to ensure sequence control so that the deformable mirror used in the imaging section is not driven during the driving of the mechanical shutter, CCD store read out, the exposure process such as stroboscopic light-emission, the display of an image photographed after the exposure process, and the record in the memory card. Moreover, in FIG. 8, it is only necessary to ensure the sequence control so that the deformable mirror used in the imaging section is not driven during the range measurement process.

Also, in addition to the structure that the deformable mirror is driven by electrostatic attraction, the deformable mirror used in the present invention may, of course, have the structure that the reflecting surface can be driven by using an electric force, for example, as in the driving by an electromagnetic force or the use of a piezoelectric effect.

The sequence control in the present invention is applicable to a camera in which a part of the imaging system is provided with a variable focal-length lens, which is deformed by the electric force to change the focal position of the lens system.

When such a deformable mirror is driven, a case occurs in which optical performance cannot be set with a high degree of accuracy, as designed, due to the manufacturing error of components themselves of the electrodes constituting the deformable mirror or the assembly error of the components. Depending on the practice of the driving of the deformable mirror, for example, even when the deformable mirror is returned to the initial state, there is the fear that a preset planar shape is not obtained.

The driving device of the deformable mirror according to the present invention is thus constructed so that after the deformable mirror is incorporated in the camera, the errors of individual electrodes and the reflecting surface constituting the deformable mirror and their assembly are measured in the initial state and a state according to the photographic condition; voltages for correction, applied to individual electrodes constituting the deformable mirror, for correcting the difference of the design value between an ordinary planar shape (in the initial state) and the deformed state in the photographic condition are prestored in the EEPROM 14 of FIG. 1; and the design values of voltages applied to the electrodes constituting the deformable mirror are corrected in accordance with the photographic condition.

When the deformable mirror is used in the imaging section for the autofocus operation or correction for hand shake, voltages for correction for correcting eccentricity and inclination caused after the assembly of a front lens unit and a rear lens unit which are separated by the deformable mirror are prestored in the EEPROM 14 of FIG. 1. When the deformable mirror is driven, the design values of voltages applied to the electrodes of the deformable mirror are corrected, and thereby the performance of the photographic lens can be improved.

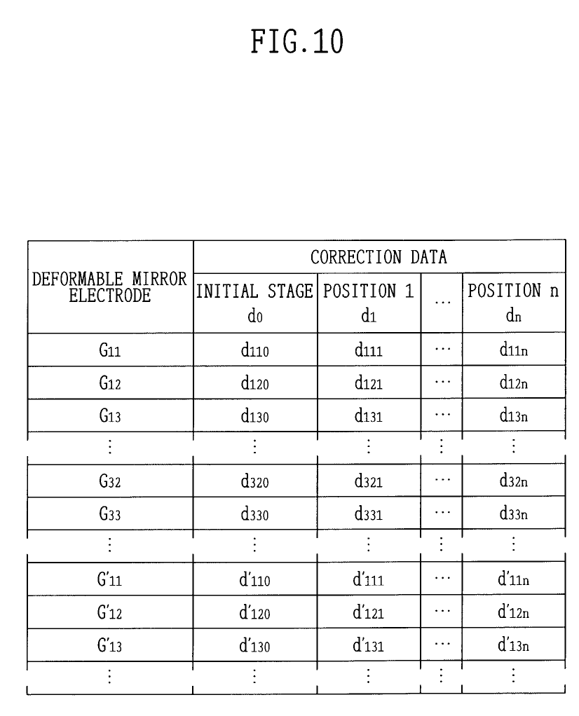

FIG. 10 shows a memory data construction inside the EEPROM 14 which is an essential part of the driving device of the deformable mirror of the embodiment. It is assumed that the lower electrodes constituting the deformable mirror, as illustrated in FIG. 4, are arrayed like checkers (the number of checkers is not limited to that of FIG. 4 and can be set at will), and the electrodes are represented by G₁₁, G₁₂, . . . . Driving voltage values applied to the electrodes required for bringing the mirror into the initial state where the surface of the electrode becomes planar in design, due to the assembly error caused when the deformable mirror is fabricated or the manufacturing error of each of the electrodes, are represented by d₁₁₀, d₁₂₀, . . . . Also, it is assumed that the positions of the range measurement of the object vary from 1 and n, and the positions of the electrodes in this case range from 1 to n. Driving voltage values at the positions of the range measurement in the electrodes are denoted by d₁₁₁-d₁₁ₙ, d₁₂₁-d₁₂ₙ, . . . . These driving voltage values are measured when the deformable mirror is fabricated and the camera is assembled, and their data are stored in the EEPROM 14 of FIG. 1. For the driving voltage values, where the deformable mirror is incorporated in the photographic lens system as shown in FIG. 8 or 9, as well as where it is incorporated in the range measurement section as shown in FIG. 5, driving voltage values d′₁₁₀, d′₁₂₀, . . . in the initial state and driving voltage values d′₁₁₁-d′₁₁ₙ, d′₁₂₁-d′₁₂ₙ, . . . at the positions 1-n of the electrodes corresponding to the focal distances 1-n are measured and stored in the EEPROM 14.

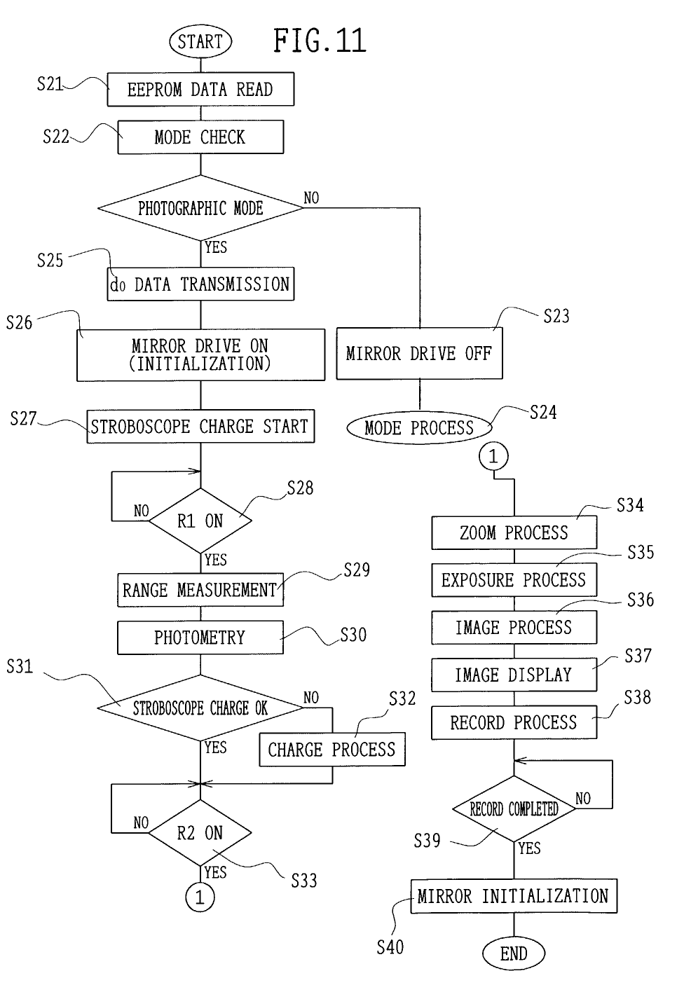

FIG. 11 is the flowchart of driving control on photographing in the camera provided with the driving device of the deformable mirror of the embodiment. In FIG. 11, when the camera is turned on, various data stored in the EEPROM 14 of the camera are first read out (Step S21). The driving voltage value is contained in these data. Subsequently, a mode selecting image is displayed, for example, on the mode LCD 9 of the camera in FIG. 1, and the photographer makes a mode selection. The mode selected by the photographer is checked (Step S22).

When a photographic mode is not selected, the power source of the drive of the deformable mirror, such as a driving power, of power sources from the power circuit 12 of FIG. 1 is turned off so that the power is not supplied to the voltage control circuit 24 of FIG. 2 (Step S23), and various modes selected thereafter are processed (Step S24). Also, for the mode selection, there are a photographic mode, a reproducing mode for photographic images, a setting mode for various numerical values, and an exterior communication mode. For convenience of description, however, reference is here made to the case where the photographic mode is selected.

When the photographic mode is selected, the power source of the drive of the deformable mirror is turned on, and the voltage is applied to the voltage control circuit 24 at preset timing, by preset driving voltage values (d₁₁₀, d₁₂₀, . . . , d′₁₁₀, d′₁₂₀, . . . in FIG. 10) previously read out from the EEPROM 14, with respect to the electrodes 22 of FIG. 2 constituting the deformable mirror provided in the range measurement section or the photographic lens system (Step S25). The orientation and deformed state of the reflecting surface 23 are brought into the initial state as designed (Step S26).

After that, a stroboscope charge process is started (Step S27). Whether a release button is half-pushed is checked, and this procedure is repeated until the release button is half-pushed (Step S28). When the release button is half-pushed, the range measurement process is executed (Step S29).

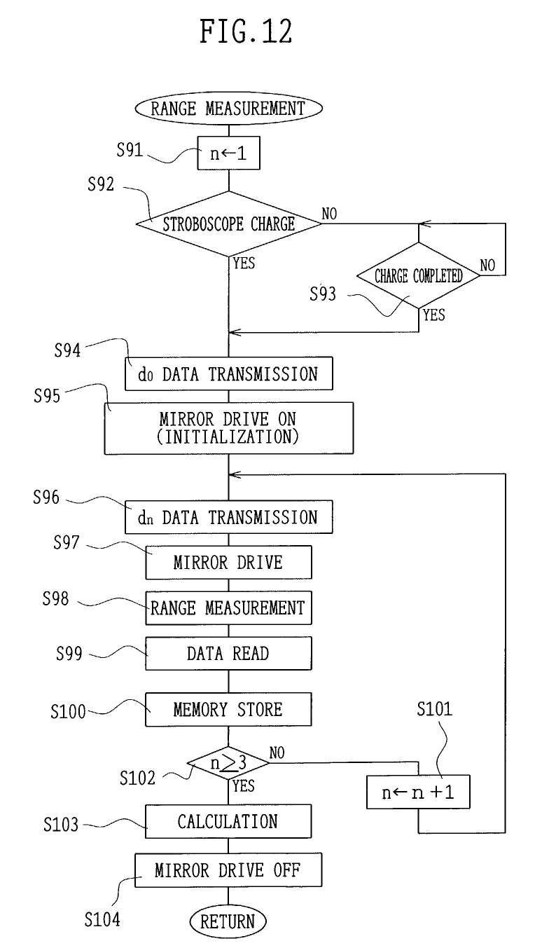

FIG. 12 is the flowchart of the range measurement process in the camera provided with the driving device of the deformable mirror of the embodiment. In the range measurement process, 1 is set to the measuring position counter n as an initial process (Step S91). Next, whether a stroboscope is charged is checked (Step S92), and when it is charged, the process is placed in a wait state until the charge is completed (Step S93).

When the charge of the stroboscope is not completed or a stroboscope charge operation is not performed, the power source of the drive of the deformable mirror provided in the range measurement section is turned on to supply the power to the voltage control circuit 24 at preset timing, by preset driving voltage values (d₁₁₀, d₁₂₀, . . . in FIG. 10) previously read out from the EEPROM 14 (Step S94). The orientation and deformed state of the reflecting surface 23 are brought into the initial state as designed (Step S95).

The voltage is supplied to the voltage control circuit 24 to drive the electrodes 22, by preset driving voltage values (corresponding data of d₁₁₁-d₁₁ₙ, d₁₂₁-d₁₂ₙ, . . . in FIG. 10) previously read out from the EEPROM 14, so that the distance of a position corresponding to the measuring position counter n (for example, the position of one of the arrows a, b, and c in FIG. 5) can be measured and the profile of the reflecting surface 23 can be changed (Step S96, S97). The distance of the object to be measured at this position is measured (Step S98). A measured value according to the output signal of the light receiver 37 of FIG. 5 is read out (Step S99) and is temporarily stored in the buffer memory 7 of FIG. 1 (Step S100).

After that, 1 is added to the measuring position counter n (Step S101), and until the range measurement of the entire area of the photographic image relative to the object to be measured is completed (until the counter n reaches 3 in the figure), the range measurements at the corresponding positions are made and procedure that each of measured values thus obtained is stored in the buffer memory 7 is repeated (Step S102). The area of the photographic image may be scanned two-dimensionally.

Of the positions of the arrows a, b, and c, the position of the arrow a may be thought of as the position of the initial state. In this case, it is only necessary to measure the displacement of the remaining positions of the arrows b and c, and thus the number of position settings can be decreased.

Subsequently, the voltage applied to the corresponding electrode of the deformable mirror constituting the photographic lens system 1 of FIG. 1 to be driven is calculated from the above measured value so that the object located at a desired position is imaged on the image sensor through the photographic lens system 1 (Step S103), and then the power source of the drive of the deformable mirror is turned off (Step S104). In this way, the range measurement process (Step S29) is completed.

In the check of the stroboscope charge, when the stroboscope is charged, the procedure may be varied so that the charge of the stroboscope is stopped temporarily for the priority of processing after the driving of the deformable mirror in the range measurement section; after the profile of the reflecting surface 23 is changed through the driving voltage values (corresponding data of d₁₁₁-d₁₁ₙ, d₁₂₁-d₁₂ₙ, . . in FIG. 10), the range measurement at the corresponding position is made; the measured value thus available is stored in the buffer memory; the voltage applied to each of the electrodes of the deformable mirror constituting the photographic lens system 1 is calculated from the measured value (Step S99-Step S103); and after the power source of the drive of the deformable mirror is turned off (Step S104), the charge of the stroboscope is started again.

After the range measurement process (Step S29) is completed, as shown in FIG. 11, a photometric process (Step S30) is performed. Then, in the case of stroboscopic photography, whether the stroboscope is charged is checked (Step S31), and when it is charged, the process is placed in the wait state until the charge is completed (Step S32). When the charge of the stroboscope is completed or has been completed, the process is placed in the wait state until the release button is fully pushed (Step S33).

When the release button is fully pushed, a zoom process is executed (Step S34) so that the object at a desired position is imaged on the image sensor 3 through the photographic lens system 1.

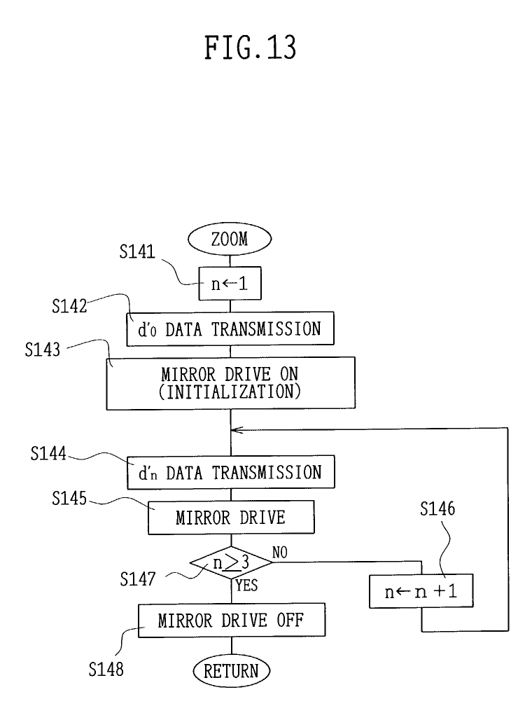

FIG. 13 is the flowchart of the zoom process in the camera provided with the driving device of the deformable mirror of the embodiment. In the zoom process, 1 is set to the measuring position counter n as the initial process (Step S141). Next, the power source of the drive of the deformable mirror constituting the photographic lens system 1 is turned on, and the voltage is applied to the voltage control circuit 24 at the preset timing, by the preset driving voltage values (d′₁₁₀, d′₁₂₀, . . . in FIG. 10) previously read out from the EEPROM 14 (Step S142). The orientation and deformed state of the reflecting surface are brought into the initial state as designed (Step S143).

After that, the power is supplied to the voltage control circuit 24 to drive the mirror (Step S144, S145), by the preset driving voltage values (corresponding data of d′111-d′₁₁ₙ, d′₁₂₁-d′₁₂ₙ, . . . in FIG. 10) previously read out from the EEPROM 14, from a calculated value obtained by the range measurement process. The voltage is applied to a corresponding electrode (corresponding data of G′₁₁, G′₁₂, . . . in FIG. 10) and the shape of the mirror is changed so as to bring about the same effect that the lens drive 2 of FIG. 1 drives the photographic lens system 1 (zoom driving).

After that, 1 is added to the measuring position counter n (Step S146), and until the range measurement of the entire area of the photographic image relative to the object to be measured is completed (until the counter n reaches 3 in the figure), the range measurements at the corresponding positions are made and procedure that each of measured values is stored in the memory is repeated (Step S147). The zoom driving by the electrodes of the deformable mirror constituting the photographic lens system may be performed two-dimensionally. The power source of the drive of the deformable mirror is then turned off (Step S148). In this way, the zoom process (Step S34) is completed.

Also, in addition to the driving mentioned above, the lens drive 2 is designed to carry out the driving for changing the magnification of the photographic lens system 1 and the driving of lenses constituting the photographic lens system 1, from a collapsible position to a photographic position.

In FIG. 11, after the zoom process is completed, the exposure process is executed (Step S35). In the exposure process, the driving of the mechanical shutter, the control of the image sensor 3, and the exposure operation such as stroboscopic light-emission are performed on the basis of the aperture of the stop and a shutter speed which are determined in accordance with values obtained by the photometric process, and the image process is executed on the basis of an image signal obtained (Step S36). After that, a photographed image is displayed (Step S37) and is recorded in a recording medium, such as a memory card, by the operation of the photographer as occasion demands (Step S38).

During this operation, the power source of the drive of the deformable mirror is held in an off state. After the record of image information is completed (Step S39), the power source of the drive of the deformable mirror is turned on, and the orientation and deformed state of the reflecting surface is initialized by the electrodes constituting the deformable mirror (Step S40). The power source of the drive of the deformable mirror is then turned off and the photographic process of one frame is completed.

Thus, according to the embodiment, the driving device of the deformable mirror has a memory for storing a corrected value of the control voltage of each electrode so that an optical error is corrected when adjustment is made after the deformable mirror is fabricated and incorporated in the camera. Furthermore, the driving device is such that the driving voltage value of each electrode prestored is read out and the driving control is made in accordance with this value. The error of the optical system, therefore, can be simply corrected.

The operation for initializing each electrode is performed before photographing where the photographic mode is selected, the release button is half-pushed, or the monitor is outputted, and hence the effect that the setting of the last photography is not affected is obtained.

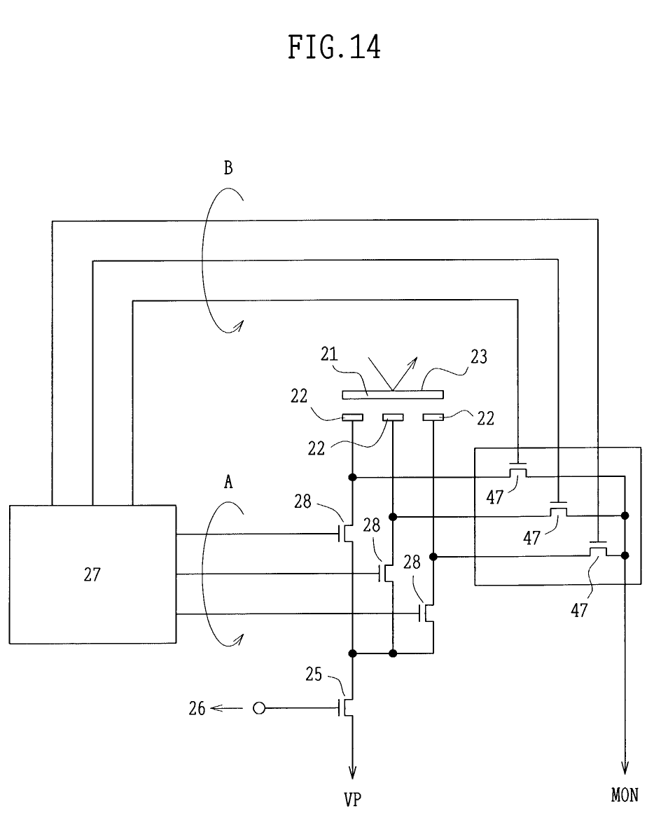

The driving circuit of the deformable mirror of the present invention, as shown in FIG. 2, is provided with an output terminal MON for monitor feedback as a monitor output means for monitoring voltages flowing through the electrodes 22 in order to suppress a voltage change by leak in an operation in which accuracy is required or a long-time exposure operation. The driving circuit, as shown in FIG. 14, is further provided with switching transistors 47 for monitor feed back, and a selecting circuit for selecting so that the switching of the timing generating circuit 27 is actuated with respect to an A group or a B group is incorporated in the timing generating circuit 27 to control the voltages in accordance with a monitored state at the output terminal MON of the voltages applied to the electrodes 22. It is desirable that the driving device is constructed in this way.

In FIG. 14, when the A group is selected, the voltages are applied to the control electrodes through the switching transistors 28, while when the B group is selected, the voltages of the control electrodes selected through the switching transistors 47 are monitored through the monitor means, not shown, connected to the output terminal MON for monitor feedback. By doing so, information on a holding voltage state can be monitored with analog or digital from the exterior, and even when accuracy is required for voltage control or the voltage value is affected by ambiance, the state can be easily judged. Thus, for example, in accordance with the result of the monitor, the voltage is applied again to an electrode to which a voltage to be applied appears to be lower than the preset voltage value, and thereby it becomes possible to make the voltage control with a high degree of accuracy.

Also, in addition to the structure that the deformable mirror is driven by electrostatic attraction, the deformable mirror used in the present invention may, of course, have the structure that the reflecting surface can be driven by using an electric force, for example, as in the driving by an electromagnetic force or the use of a piezoelectric effect.

The sequence control of the driving device of the deformable mirror in the present invention is applicable to a driving device in which a part of the imaging system is provided with a variable focal-length lens, which is deformed by the electric force to change the focal position of the lens system.

Subsequently, a description will be given of the examples of structures of the deformable mirror, the variable focal-length lens, and the like which are applicable to the present invention.

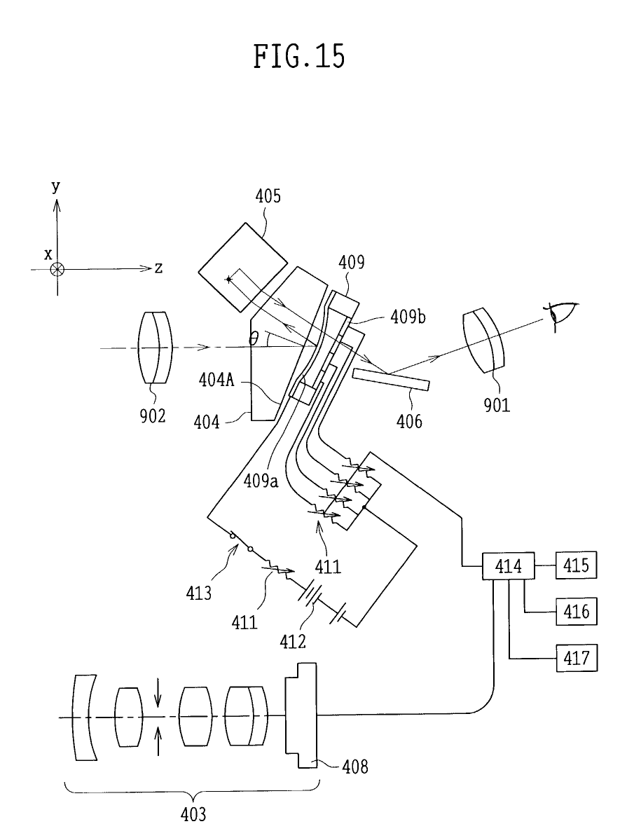

FIG. 15 shows a Keplerian finder for a digital camera using a variable optical-property mirror as a variable mirror applicable to the zooming optical system of the present invention. It can, of course, be used for a silver halide film camera. Reference is first made to a variable optical-property mirror 409.

The variable optical-property mirror 409 refers to an optical-property deformable mirror (which is hereinafter simply called the deformable mirror) comprised of a thin film (reflecting surface) 409a coated with aluminum and a plurality of electrodes 409b. Reference numeral 411 denotes a plurality of variable resistors connected to the electrodes 409b; 412 denotes a power supply connected between the thin film 409a and the electrodes 409b through the variable resistors 411 and a power switch 413; 414 denotes an arithmetical unit for controlling the resistance values of the variable resistors 411; and 415, 416, and 417 denote a temperature sensor, a humidity sensor, and a range sensor, respectively, connected to the arithmetical unit 414, which are arranged as shown in the figure to constitute one optical apparatus.

Each of the surfaces of an objective lens 902, an eyepiece 901, a prism 404, an isosceles rectangular prism 405, a mirror 406, and the deformable mirror 409 need not necessarily be planar, and may have any shape such as a spherical or rotationally symmetrical aspherical surface; a spherical, planar, or rotationally symmetrical aspherical surface which is decentered with respect to the optical axis; an aspherical surface with symmetrical surfaces; an aspherical surface with only one symmetrical surface; an aspherical surface with no symmetrical surface; a free-formed surface; a surface with a nondifferentiable point or line; etc. Moreover, any surface which has some effect on light, such as a reflecting or refracting surface, is satisfactory. In general, such a surface is hereinafter referred as to an extended surface.

The thin film 409a, like a membrane mirror set forth, for example, in “Handbook of Microlithography, Micromachining and Microfabrication”, by P. Rai-Choudhury, Volume 2: Micromachining and Microfabrication, p. 495, Fig. 8.58, SPIE PRESS, or Optics Communication, Vol. 140, pp. 187-190, 1997, is such that when the voltage is applied across the plurality of electrodes 409b, the thin film 409a is deformed by the electrostatic force and its surface profile is changed. Whereby, not only can focusing be adjusted to the diopter of an observer, but also it is possible to suppress deformations and changes of refractive indices, caused by temperature and humidity changes of the lenses 902 and 901 and/or the prism 404, the isosceles rectangular prism 405, and the mirror 406, or the degradation of imaging performance by the expansion and deformation of a lens frame and assembly errors of parts, such as optical elements and frames. In this way, a focusing adjustment and correction for aberration produced by the focusing adjustment can be always properly made.

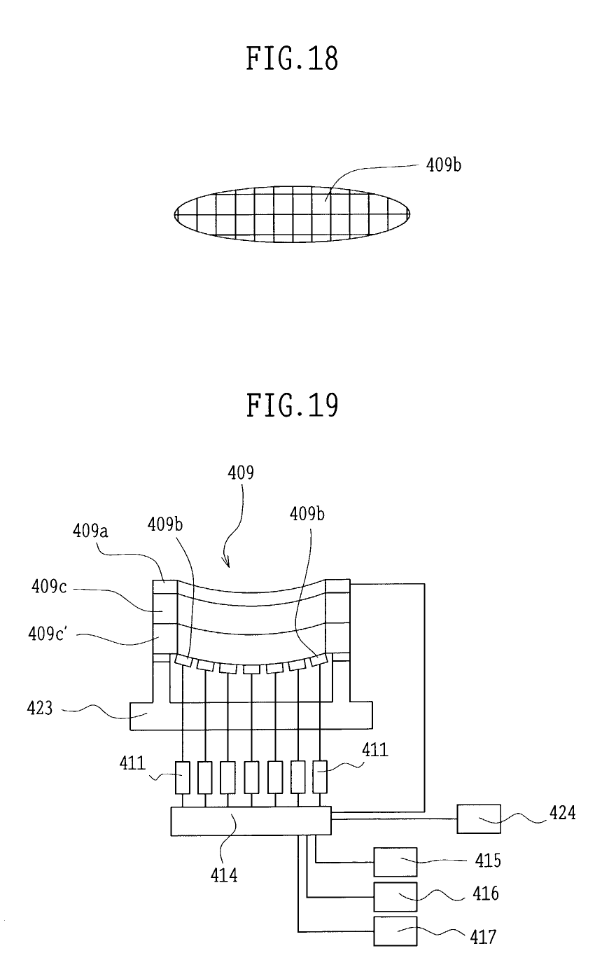

Also, it is only necessary that the shape of the electrodes 409b, for example, as shown in FIGS. 17 and 18, is selected in accordance with the deformation of the thin film 409a.

According to the embodiment, light from an object is refracted by the entrance and exit surfaces of the objective lens 902 and the prism 404, and after being reflected by the deformable mirror 409, is transmitted through the prism 404. The light is further reflected by the isosceles rectangular prism 405 (in FIG. 15, a mark + on the optical path indicates that a ray of light travels toward the back side of the plane of the page), and is reflected by the mirror 406 to enter the eye through the eyepiece 901. As mentioned above, the lenses 902 and 901, the prisms 404 and 405, and the deformable mirror 409 constitute the observing optical system of the optical apparatus in the embodiment. The surface profile and thickness of each of these optical elements is optimized and thereby aberration can be minimized.

Specifically, the configuration of the thin film 409a, as the reflecting surface, is controlled in such a way that the resistance values of the variable resistors 411 are changed by signals from the arithmetical unit 414 to optimize imaging performance. Signals corresponding to ambient temperature and humidity and a distance to the object are input into the arithmetical unit 414 from the temperature sensor 415, the humidity sensor 416, and the range sensor 417. In order to compensate for the degradation of imaging performance due to the ambient temperature and humidity and the distance to the object in accordance with these input signals, the arithmetical unit 414 outputs signals for determining the resistance values of the variable resistors 411 so that voltages by which the configuration of the thin film 409a is determined are applied to the electrodes 409b. Thus, since the thin film 409a is deformed with the voltages applied to the electrodes 409b, that is, the electrostatic force, it assumes various shapes including an aspherical surface, according to circumstances. The range sensor 417 need not necessarily be used, and in this case, it is only necessary that an imaging lens 403 of the digital camera is moved so that a high-frequency component of an image signal from a solid-state image sensor 408 is roughly maximized, and the object distance is calculated from this position so that an observer's eye is able to focus upon the object image by deforming the deformable mirror.

When the thin film 409a is made of synthetic resin, such as polyimide, it can be considerably deformed even at a low voltage, which is advantageous. Also, the prism 404 and the deformable mirror 409 can be integrally configured into a unit.

Although not shown in the figure, the solid-state image sensor 408 may be constructed integrally with the substrate of the deformable mirror 409 by a lithography process.

When each of the lenses 901 and 902, the prisms 404 and 405, and the mirror 406 is configured by a plastic mold, an arbitrary curved surface of a desired configuration can be easily obtained and its fabrication is simple. In the photographing apparatus of the embodiment, the lenses 902 and 901 are arranged separately from the prism 404. However, if the prisms 404 and 405, the mirror 406, and the deformable mirror 409 are designed so that aberration can be eliminated without providing the lenses 902 and 901, the prisms 404 and 405 and the deformable mirror 409 will be configured as one optical block, and the assembly is facilitated. Parts or all of the lenses 902 and 901, the prisms 404 and 405, and the mirror 406 may be made of glass. By doing so, a photographing apparatus with a higher degree of accuracy is obtained.

Also, although in FIG. 15 the arithmetical unit 414, the temperature sensor 415, the humidity sensor 416, and the range sensor 417 are provided so that the deformable mirror 409 compensates for the changes of the temperature, the humidity, and the object distance, the present invention is not limited to this construction. That is, the arithmetical unit 414, the temperature sensor 415, the humidity sensor 416, and the range sensor 417 may be eliminated so that the deformable mirror 409 compensates for only a change of an observer's diopter.

Subsequently, reference is made to other structures of the deformable mirror 409.

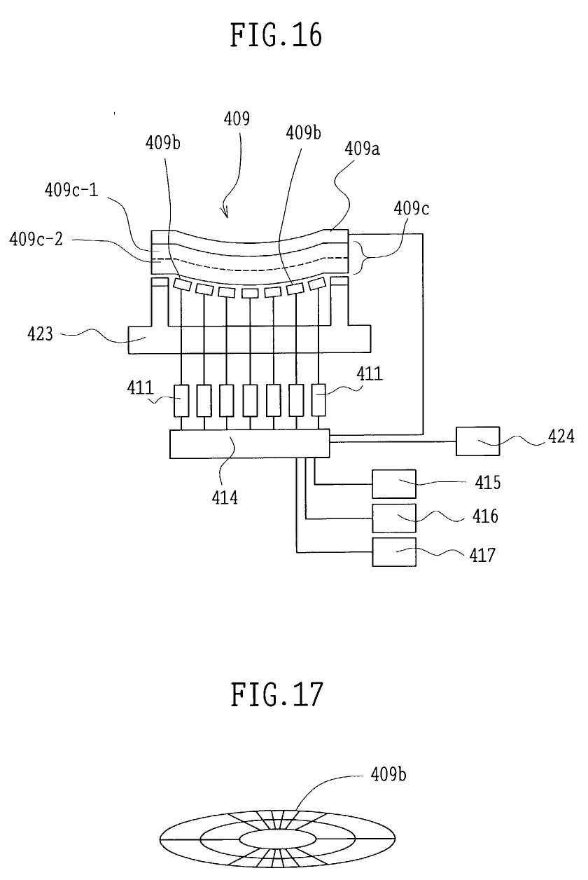

FIG. 16 shows another embodiment of the deformable mirror 409 applicable as the variable mirror according to the zooming optical system of the present invention. In this embodiment, a piezoelectric element 409c is interposed between the thin film 409a and the electrodes 409b, and these are placed on a support 423. A voltage applied to the piezoelectric element 409c is changed in accordance with the individual electrodes 409b, and thereby the piezoelectric element 409c causes expansion or contraction which is partially different so that the shape of the thin film 409a can be changed. The configuration of the electrodes 409b may be selected in accordance with the deformation of the thin film 409a. For example, as illustrated in FIG. 17, it may have a concentric division pattern, or as in FIG. 18, it may be a rectangular division pattern. As other patterns, proper configurations can be chosen. In FIG. 16, reference numeral 424 represents a shake sensor connected to the arithmetical unit 414. The shake sensor 424, for example, detects the shake of a digital camera and changes the voltages applied to the electrodes 409b through the arithmetical unit 414 and the variable resistors 411 in order to deform the thin film 409a to compensate for the blurring of an image caused by the shake. At this time, the signals from the temperature sensor 415, the humidity sensor 416, and range sensor 417 are taken into account simultaneously, and focusing and compensation for temperature and humidity are performed. In this case, stress is applied to the thin film 409a by the deformation of the piezoelectric element 409c, and hence it is good practice to design the thin film 409a so that it has a moderate thickness and a proper strength.

FIG. 19 shows still another embodiment of the deformable mirror 409 applicable as the variable mirror according to the zooming optical system of the present invention. This embodiment has the same construction as the embodiment of FIG. 16 with the exception that two piezoelectric elements 409c and 409c′ are interposed between the thin film 409a and the electrodes 409b and are made with substances having piezoelectric characteristics which are reversed in direction. Specifically, when the piezoelectric elements 409c and 409c′ are made with ferroelectric crystals, they are arranged so that their crystal axes are reversed in direction with respect to each other. In this case, the piezoelectric elements 409c and 409c′ expand or contract in a reverse direction when voltages are applied, and thus there is the advantage that a force for deforming the thin film 409a becomes stronger than in the embodiment of FIG. 16 and as a result, the shape of the mirror surface can be considerably changed.

For substances used for the piezoelectric elements 409c and 409c′, for example, there are piezoelectric substances such as barium titanate, Rochelle salt, quartz crystal, tourmaline, KDP, ADP, and lithium niobate; polycrystals or crystals of the piezoelectric substances; piezoelectric ceramics such as solid solutions of PbZrO₃ and PbTiO₃; organic piezoelectric substances such as PVDF; and other ferroelectrics. In particular, the organic piezoelectric substance has a small value of Young's modulus and brings about a considerable deformation at a low voltage, which is favorable. When the piezoelectric elements 409c and 409c′ are used, it is also possible to properly deform the thin film 409a in the above embodiment if their thicknesses are made uneven.

For materials of the piezoelectric elements 409c and 409c′, high-polymer piezoelectrics such as polyurethane, silicon rubber, acrylic elastomer, PZT, PLZT, and PVDF; vinylidene cyanide copolymer; and copolymer of vinylidene fluoride and trifluoroethylene are used.

The use of an organic substance, synthetic resin, or elastomer, having a piezoelectric property, brings about a considerable deformation of the surface of the deformable mirror, which is favorable.

When an electrostrictive substance, for example, acrylic elastomer or silicon rubber, is used for the piezoelectric element 409c shown in FIGS. 16 and 19, the piezoelectric element 409c, as indicated by a broken line in FIG. 16, may be constructed by cementing another substrate 409c-1 to an electrostrictive substance 409c-2.

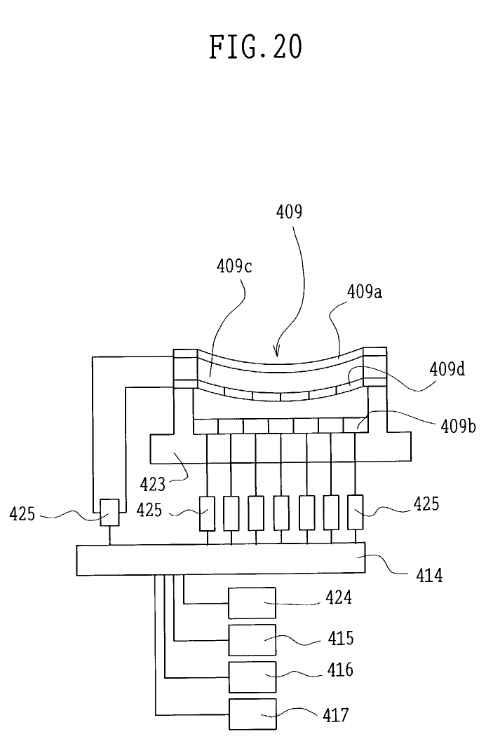

FIG. 20 shows another embodiment of the deformable mirror 409 applicable as the variable mirror according to the zooming optical system of the present invention. The deformable mirror 409 of this embodiment is designed so that the piezoelectric element 409c is sandwiched between the thin film 409a and an electrode 409d, and voltages are applied between the thin film 409a and the electrode 409d through a driving circuit 425′ controlled by the arithmetical unit 414. Furthermore, voltages are also applied to the electrodes 409b provided on the support 423, through driving circuits 425 controlled by the arithmetical unit 414. In this embodiment, therefore, the thin film 409a can be doubly deformed by electrostatic forces due to the voltages applied between the thin film 409a and the electrode 409d and applied to the electrodes 409b. There are advantages that various deformation patterns can be provided and the response is quick, compared with any of the above embodiments.

By changing the signs of the voltages applied between the thin film 409a and the electrode 409d, the deformable mirror can be deformed into a convex or concave surface. In this case, a considerable deformation may be performed by a piezoelectric effect, while a slight shape change may be carried out by the electrostatic force. Alternatively, the piezoelectric effect may be used for the deformation of the convex surface, while the electrostatic force may be used for the deformation of the concave surface. Also, the electrode 409d may be constructed as a plurality of electrodes like the electrodes 409b. This condition is shown in FIG. 20. In the present invention, all of the piezoelectric effect, the electrostrictive effect, and electrostriction are generally called the piezoelectric effect. Thus, it is assumed that the electrostrictive substance is included in the piezoelectric substance.

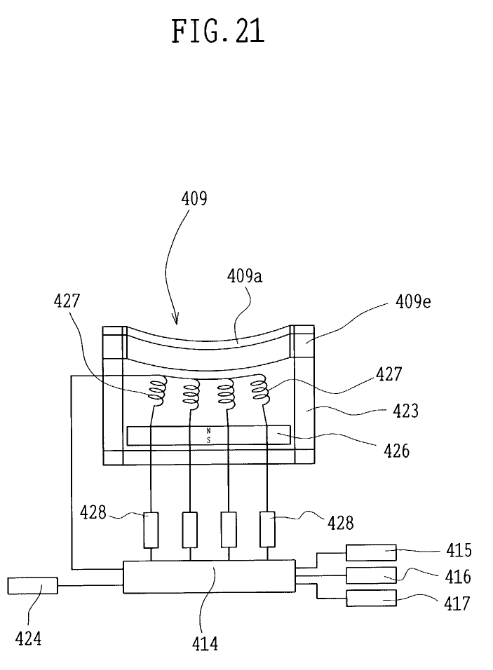

FIG. 21 shows another embodiment of the deformable mirror 409 applicable as the variable mirror according to the zooming optical system of the present invention. The deformable mirror 409 of this embodiment is designed so that the shape of the reflecting surface can be changed by utilizing an electromagnetic force. A permanent magnet 426 mounted and fixed on a bottom surface inside the support 423, and the periphery of a substrate 409e made with silicon nitride or polyimide is mounted on the top surface thereof. The thin film 409a consisting of the coating of metal, such as aluminum, is deposited on the surface of the substrate 409e, thereby constituting the deformable mirror 409. Below the substrate 409e, a plurality of coils 427 are arranged and connected to the arithmetical unit 414 through the driving circuits 428. In accordance with output signals from the arithmetical unit 414 corresponding to changes of the optical system obtained at the arithmetical unit 414 by signals from the sensor 415, 416, 417, and 424, proper electric currents are supplied from the driving circuits 428 to the coils 427. At this time, the coils 427 are repelled or attracted by the electromagnetic force with the permanent magnet 426 to deform the substrate 409e and the thin film 409a.

In this case, a different amount of current can also be caused to flow through each of the coils 427. A single coil 427 may be used, and the permanent magnet 426 may be provided on the substrate 409e so that the coils 427 are arranged on the bottom side in the support 423. It is desirable that the coils 427 are fabricated by a lithography process. A ferromagnetic core (iron core) may be encased in each of the coils 427.

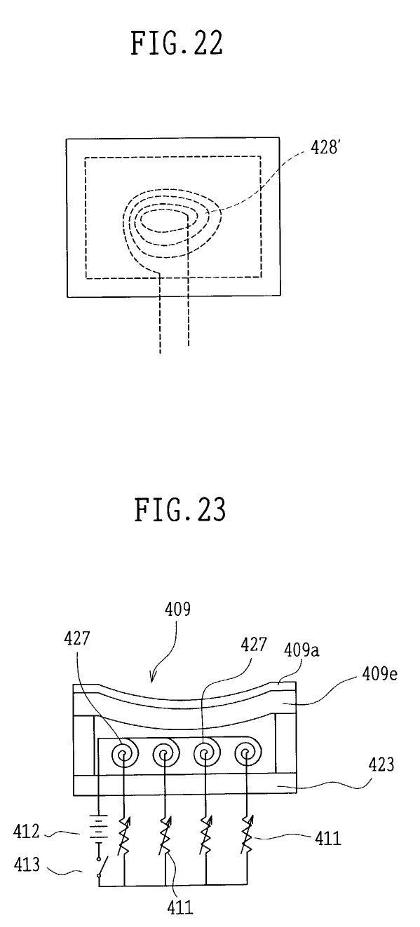

In this case, each of the coils 427, as illustrated in FIG. 22, can be designed so that a coil density varies with place and thereby a desired deformation is brought to the substrate 409e and the thin film 409a. A single coil 427 may be used, and a ferromagnetic core (iron core) may be encased in each of the coils 427.

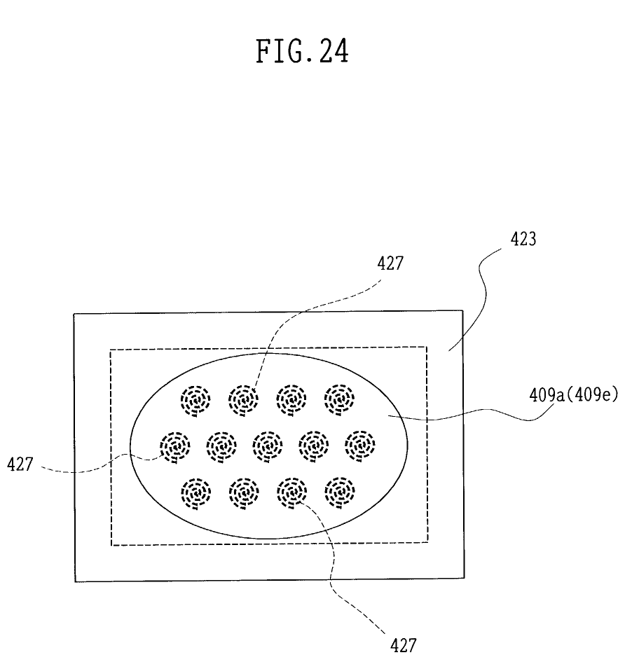

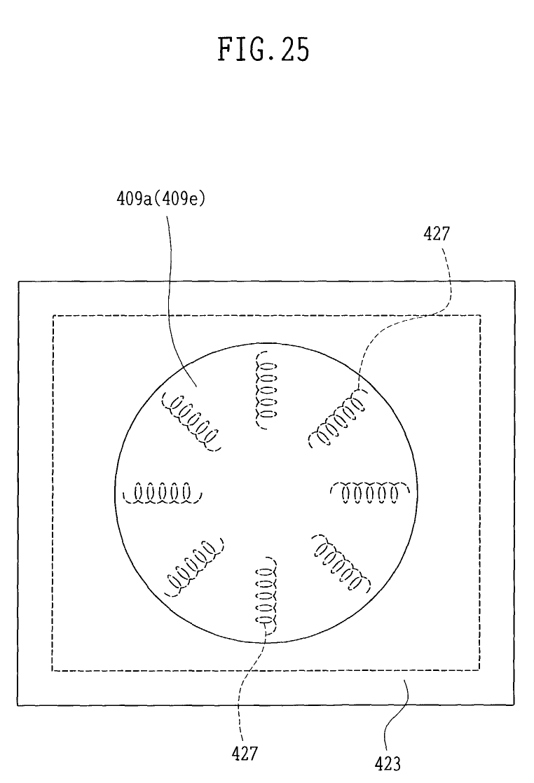

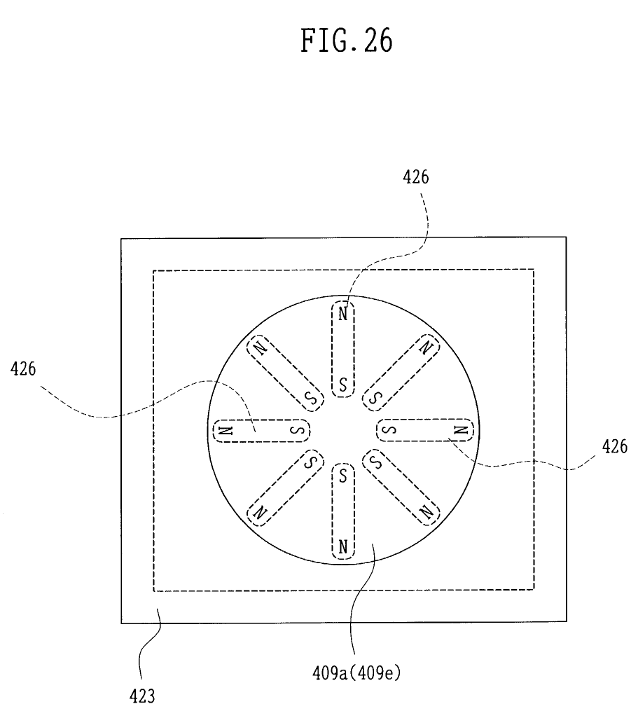

FIG. 23 shows another embodiment of the deformable mirror 409 applicable as the variable mirror according to the zooming optical system of the present invention. In the deformable mirror 409 of this embodiment, the substrate 409e is made with a ferromagnetic such as iron, and the thin film 409a as a reflecting film is made with aluminum. In this case, since the thin film coils need not be used, the structure is simple and the manufacturing cost can be reduced. If the power switch 413 is replaced with a changeover and power on-off switch, the directions of currents flowing through the coils 427 can be changed, and the configurations of the substrate 409e and the thin film 409a can be changed at will. FIG. 24 shows an array of the coils 427 in this embodiment, and FIG. 25 shows another array of the coils 427. These arrays are also applicable to the embodiment of FIG. 21. FIG. 26 shows an array of the permanent magnets 426 suitable for the array of the coils of FIG. 25 in the embodiment of FIG. 21. Specifically, when the permanent magnets 426, as shown in FIG. 26, are radially arranged, a delicate deformation can be provided to the substrate 409e and the thin film 409a in contrast with the embodiment of FIG. 21. As mentioned above, when the electromagnetic force is used to deform the substrate 409e and the thin film 409a (in the embodiments of FIGS. 21 and 23), there is the advantage that they can be driven at a lower voltage than in the case where the electrostatic force is used.

Some embodiments of the deformable mirror have been described, but as shown in FIG. 20, at least two kinds of forces may be used in order to change the shape of the deformable mirror. Specifically, at least two of the electrostatic force, electromagnetic force, piezoelectric effect, magnetrostriction, pressure of a fluid, electric field, magnetic field, temperature change, and electromagnetic wave, may be used simultaneously to deform the deformable mirror. That is, when at least two different driving techniques are used to make the variable optical-property element, a considerable deformation and a slight deformation can be realized simultaneously and a mirror surface with a high degree of accuracy can be obtained.

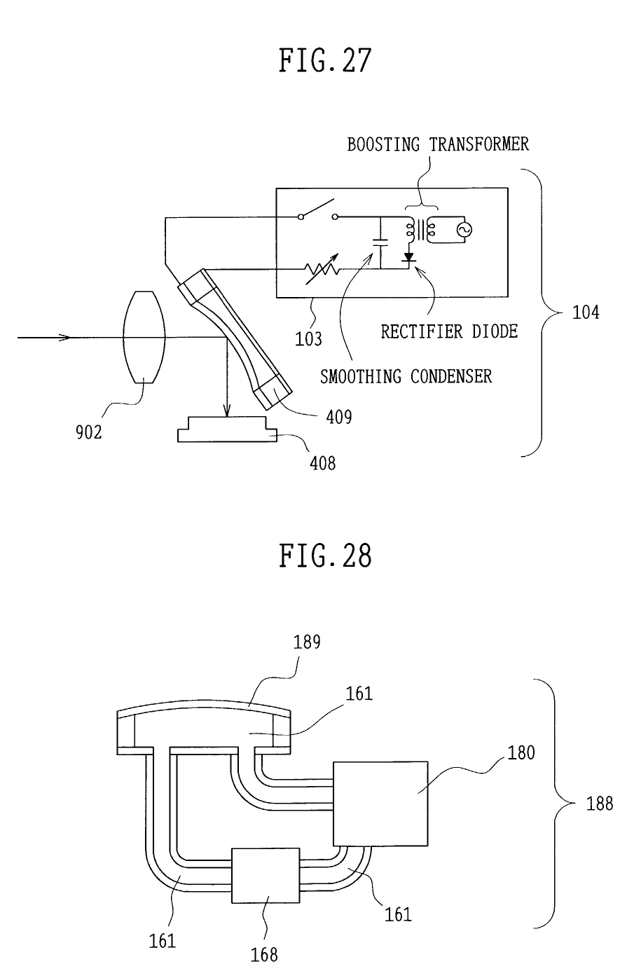

FIG. 27 shows an imaging system which uses the deformable mirror 409 as the variable mirror applicable to an imaging device using the zooming optical system, in another embodiment of the present invention, and which is used, for example, in a digital camera of a cellular phone, a capsule endoscope, an electronic endoscope, a digital camera for personal computers, or a digital camera for PDAs.

In the imaging system of this embodiment, one imaging unit 104 is constructed with the deformable mirror 409, the lens 902, the solid-state image sensor 408, and a control system 103. In the imaging unit 104 of the embodiment, light from an object passing through the lens 902 is condensed by the deformable mirror 409 and is imaged on the solid-state image sensor 408. The deformable mirror 409 is a kind of variable optical-property element and is also referred to as the variable focal-length mirror.

According to this embodiment, even when the object distance is changed, the deformable mirror 409 is deformed and thereby the object can be brought into a focus. The embodiment need not use the motor to move the lens and excels in compact and lightweight design and low power consumption. The imaging unit 104 can be used in any of the embodiments as the imaging system of the present invention. When a plurality of deformable mirrors 409 are used, a zoom or variable magnification imaging system or optical system can be constructed.

In FIG. 27, an example of a control system which includes the boosting circuit of a transformer using coils in the control system 103 is cited. When a laminated piezoelectric transformer is particularly used, a compact design is achieved. The boosting circuit can be used in the deformable mirror or the variable focal-length lens of the present invention which uses electricity, and is useful in particular for the deformable mirror or the variable focal-length lens which utilizes the electrostatic force or the piezoelectric effect.

FIG. 28 shows the deformable mirror 188 in which a fluid 161 is taken in and out by a micropump 180 to deform a mirror surface, in another embodiment, applicable as the variable mirror according to the zooming optical system of the present invention. According to this embodiment, there is the merit that the mirror surface can be considerably deformed.

The micropump 180 is a small-sized pump, for example, made by a micromachining technique and is constructed so that it is operated with an electric power. As examples of pumps made by the micromachining technique, there are those which use thermal deformations, piezoelectric substances, and electrostatic forces.

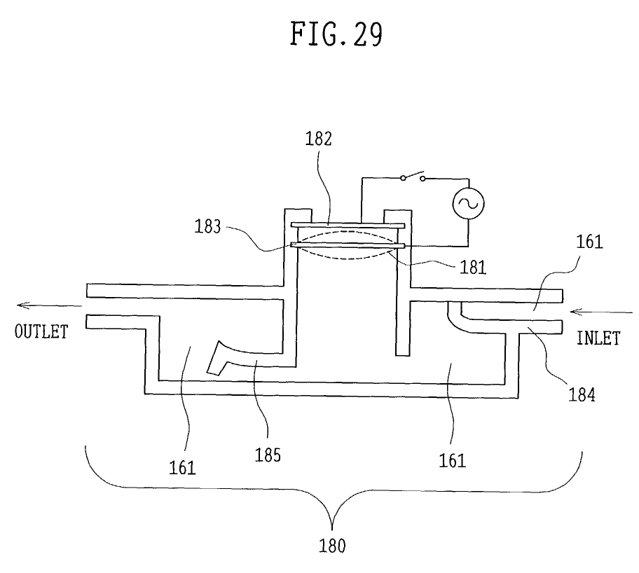

FIG. 29 shows an example of a micropump applicable to the present invention. In the micropump 180 of the embodiment, a vibrating plate 181 is vibrated by the electrostatic force or the electric force of the piezoelectric effect. In this figure, a case where the vibrating plate is vibrated by the electrostatic force is shown and reference numerals 182 and 183 represent electrodes. Dotted lines indicate the vibrating plate 181 where it is deformed. When the vibrating plate 181 is vibrated, two valves 184 and 185 are opened and closed to feed the fluid 161 from the right to the left.

In the deformable mirror 188 of this embodiment, the reflecting film 181 is deformed into a concave or convex surface in accordance with the amount of the fluid 161, and thereby functions as the deformable mirror. The deformable mirror 188 is driven by the fluid 161. An organic or inorganic substance, such as silicon oil, air, water, or jelly, can be used as the fluid.

In the deformable mirror or the variable focal-length lens which uses the electrostatic force or the piezoelectric effect, a high voltage is sometimes required for drive. In this case, for example, as shown in FIG. 27, it is desirable that the boosting transformer or the piezoelectric transformer is used to constitute the control system.

If the thin film 409a for reflection is also provided in a portion which is not deformed, it can be used as a reference surface when the profile of the deformable mirror is measured by an interferometer, which is convenient.

Subsequently, reference is made to the variable focal-length lens applicable to the camera of the present invention.

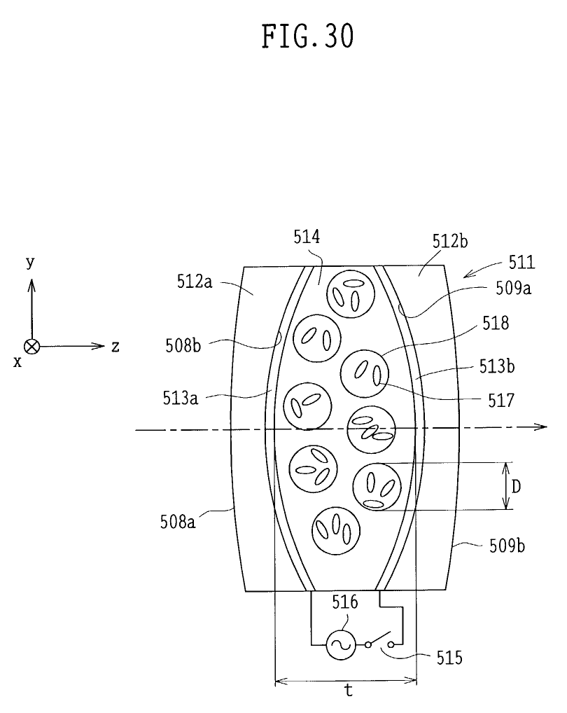

FIG. 30 shows the structure of the variable focal-length lens applicable to the zooming optical system according to the present invention. A variable focal-length lens 511 includes a first lens 512a having lens surfaces 508a and 508b as a first surface and a second surface, respectively, a second lens 512b having lens surfaces 509a and 509b as a third surface and a fourth surface, respectively, and a macromolecular dispersed liquid crystal layer 514 sandwiched between these lenses through transparent electrodes 513a and 513b. Incident light is converged through the first and second lenses 512a and 512b. The transparent electrodes 513a and 513b are connected to an alternating-current power supply 516 through a switch 515 so that an alternating-current electric field is selectively applied to the macromolecular dispersed liquid crystal layer 514. The macromolecular dispersed liquid crystal layer 514 is composed of a great number of minute macromolecular cells 518, each having any shape, such as a sphere or polyhedron, and including liquid crystal molecules 517, and its volume is equal to the sum of volumes occupied by macromolecules and the liquid crystal molecules 517 which constitute the macromolecular cells 518.

Here, for the size of each of the macromolecular cells 518, for example, in the case of a sphere, when an average diameter is denoted by D and the wavelength of light used is denoted by X, the average diameter D is chosen to satisfy the following condition:

2 nm≦D≦λ/5 (1)

That is, the size of each of the liquid crystal molecules 517 is at least about 2 nm and thus the lower limit of the average diameter D is set to about 2 nm or larger. The upper limit of the diameter D depends on a thickness t of the macromolecular dispersed liquid crystal layer 514 in the direction of the optical axis of the variable focal-length lens 511. However, if the diameter is larger than the wavelength λ, a difference between the refractive indices of the macromolecules and the liquid crystal molecules 517 will cause light to be scattered at the interfaces of the macromolecular cells 518 and will render the liquid crystal layer 514 opaque. Hence, the upper limit of the diameter D should be λ/5 or less. A high degree of accuracy is not necessarily required, depending on an optical product using the variable focal-length lens. In this case, the diameter D below the value of the wavelength λ is satisfactory. Also, the transparency of the macromolecular dispersed liquid crystal layer 514 deteriorates with increasing thickness t.

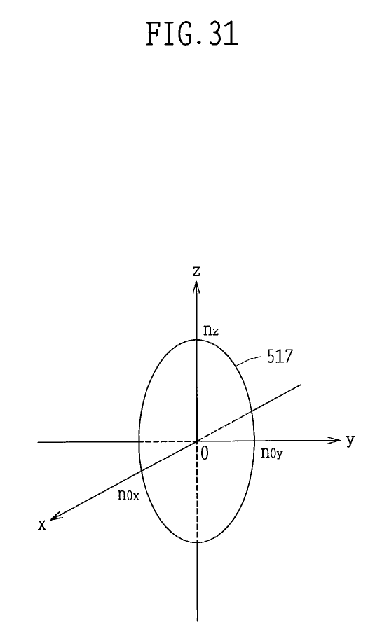

In the liquid crystal molecules 517, for example, uniaxial nematic liquid crystal molecules are used. The index ellipsoid of each of the liquid crystal molecules 517 is as shown in FIG. 31. That is,

nₒₓ=n_{oy}=nₒ (2)

where nₒ is the refractive index of an ordinary ray and nₒₓ and n_{oy} are refractive indices in directions perpendicular to each other in a plane including ordinary rays.

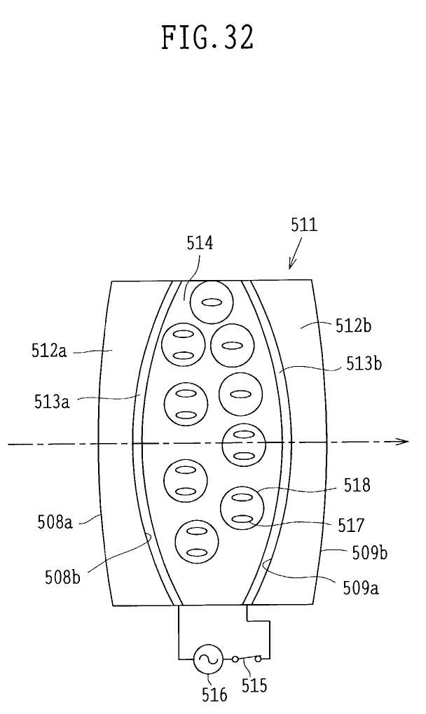

Here, in the case where the switch 515, as shown in FIG. 30 is turned off, that is, the electric field is not applied to the liquid crystal layer 514, the liquid crystal molecules 517 are oriented in various directions, and thus the refractive index of the liquid crystal layer 514 relative to incident light becomes high to provide a lens with strong refracting power. In contrast to this, when the switch 515, as shown in FIG. 32, is turned on and the alternating-current electric field is applied to the liquid crystal layer 514, the liquid crystal molecules 517 are oriented so that the major axis of the index ellipsoid of each liquid crystal molecule 517 is parallel with the optical axis of the variable focal-length lens 511, and hence the refractive index becomes lower to provide a lens with weaker refracting power.

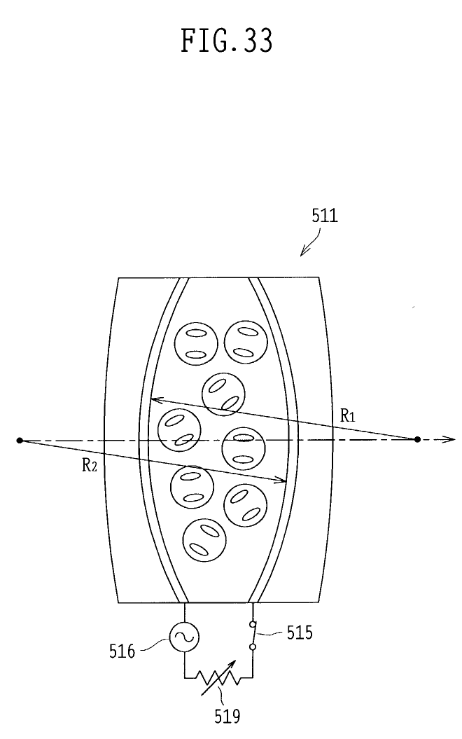

The voltage applied to the macromolecular dispersed liquid crystal layer 514, for example, as shown in FIG. 33, can be changed stepwise or continuously by a variable resistor 519. By doing so, as the applied voltage becomes high, the liquid crystal molecules 517 are oriented so that the major axis of the index ellipsoid of each liquid crystal molecule 517 becomes progressively parallel with the optical axis of the variable focal-length lens 511, and thus the refractive index can be changed stepwise or continuously.

Here, in the case of FIG. 30, that is, in the case where the electric field is not applied to the macromolecular dispersed liquid crystal layer 514, when the refractive index in the direction of the major axis of the index ellipsoid, as shown in FIG. 31, is denoted by n_{z}, an average refractive index n_{LC}′ of the liquid crystal molecules 517 is roughly given by

(nₒₓ+n_{oy}+n_{z})/3≡n_{LC}′ (3)

Also, when the refractive index n_{z} is expressed as a refractive index nₑ of an extraordinary ray, an average refractive index n_{LC} where Equation (2) is established is given by

(2nₒ+nₑ)/3≡n_{LC} (4)

In this case, when the refractive index of each of the macromolecules constituting the macromolecular cells 518 is represented by nₚ and the ratio of volume between the liquid crystal layer 514 and the liquid crystal molecules 517 is represented by ff, a refractive index n_{A} of the liquid crystal layer 514 is given from the Maxwell-Garnet's law as

n_{A}=ff·n_{LC}′+(1−ff)nₚ (5)

Thus, as shown in FIG. 33, when the radii of curvature of the inner surfaces of the lenses 512a and 512b, that is, the surfaces on the side of the liquid crystal layer 514, are represented by R₁ and R₂, a focal length f₁ of the variable focal-length lens 511 is given by

1/f₁=(n_{A}−1)(1/R₁−1/R₂) (6)

Also, when the center of curvature is located on the image side, it is assumed that the radius of curvature R₁ or R₂ is positive. Refraction caused by the outer surface of each of the lenses 512a and 512b is omitted. That is, the focal length of the lens of only the liquid crystal layer 514 is given by Equation (6).

When the average refractive index of ordinary rays is expressed as

(nₒₓ+n_{oy})/2=nₒ′ (7)

a refractive index n_{B} of the liquid crystal layer 514 in the case of FIG. 32, namely, in the case where the electric field is applied to the liquid crystal layer 514, is given by

n_{B}=ff·nₒ′+(1−ff)nₚ (8)

and thus a focal length f₂ of the lens of only the liquid crystal layer 514 in this case is given by

1/f₂=(n_{B}−1)(1/R₁−1/R₂) (9)

Also, the focal length where a lower voltage than in FIG. 32 is applied to the liquid crystal layer 514 is a value between the focal length f₁ given by Equation (6) and the focal length f₂ by Equation (9).

From Equations (6) and (9), a change rate of the focal length by the liquid crystal layer 514 is given by

|(f₂−f)/f₂|=|(n_{B}−n_{A})/(n_{B}−1)| (10)

Thus, in order to increase the change rate, it is only necessary to increase the value of |(n_{B}−n_{A})|. Here,

n_{B}−n_{A}=ff(nₒ′−n_{LC}′) (11)

and hence if the value of |nₒ′−n_{LC}′| is increased, the change rate can be raised. Practically, since the refractive index n_{B} is about 1.3-2, the value of |nₒ′−n_{LC}′| is chosen so as to satisfy the following condition:

0.01≦|nₒ′−n_{LC}′|≦10 (12)

In this way, when ff=0.5, the focal length obtained by the liquid crystal layer 514 can be changed by at least 0.5%, and thus an effective variable focal-length lens can be realized. Also, the value of |nₒ′−n_{LC}′| cannot exceed 10 because of restrictions on liquid crystal substances.

Subsequently, a description will be given of grounds for the upper limit of Condition (1). The variation of a transmittance τ where the size of each cell of a macromolecular dispersed liquid crystal is changed is described in “Transmission variation using scattering/transparent switching films” on pages 197-214 of “Solar Energy Materials and Solar Cells”, Wilson and Eck, Vol. 31, Eleesvier Science Publishers B. v., 1993. In Fig. 6 on page 206 of this publication, it is shown that when the radius of each cell of the macromolecular dispersed liquid crystal is denoted by r, t=300 μm, ff=0.5, nₚ=1.45, n_{LC}=1.585, and λ=500 nm, the theoretical value of the transmittance τ is about 90% if r=5 nm (D=λ/50 and D·t=λ·6 μm, where D and λ are expressed in nanometers), and is about 50% if r=25 nm (D=λ/10).

Here, it is assumed that t=150 μm and the transmittance τ varies as the exponential function of the thickness t. The transmittance T in the case of t=150 μm is nearly 71% when r=25 nm (D=λ/10 and D·t=λ·15 μm). Similarly, in the case of t=75 μm, the transmittance τ is nearly 80% when r=25 nm (D=λ/10 and D·t=λ·7.5 μm).

From these results, the transmittance τ becomes at least 70-80% and the liquid crystal can be actually used as a lens, if the liquid crystal satisfies the following condition:

D·t≦λ·15 μm (13)

Hence, for example, in the case of t=75 μm, if D≦λ/5, a satisfactory transmittance can be obtained.

The transmittance of the macromolecular dispersed liquid crystal layer 514 is raised as the value of the refractive index np approaches the value of the refractive index n_{LC}′. On the other hand, if the values of the refractive indices nₒ′ and nₚ are different from each other, the transmittance of the liquid crystal layer 514 will be degraded. In FIGS. 30 and 32, the transmittance of the liquid crystal layer 514 is improved on an average when the liquid crystal layer 514 satisfies the following equation:

nₚ=(nₒ′+n_{LC}′)/2 (14)

The variable focal-length lens 511 is used as a lens, and thus in both FIGS. 30 and 32, it is desirable that the transmittances are almost the same and high. For this, although there are limits to the substances of the macromolecules and the liquid crystal molecules 517 constituting the macromolecular cells 518, it is only necessary, in practical use, to satisfy the following condition:

nₒ′≦nₚ≦n_{LC}′ (15)

When Equation (14) is satisfied, Condition (13) is moderated and it is only necessary to satisfy the following condition:

D·t≦λ·60 μm (16)

It is for this reason that, according to the Fresnel's law of reflection, the reflectance is proportional to the square of the difference of the refractive index, and thus the reflection of light at the interfaces between the macromolecules and the liquid crystal molecules 517 constituting the macromolecular cells 518, that is, a reduction in the transmittance of the liquid crystal layer 514, is roughly proportional to the square of the difference in refractive index between the macromolecules and the liquid crystal molecules 517.

In the above description, reference has been made to the case where nₒ′≈1.45 and n_{LC}′≈1.585, but in a more general formulation, it is only necessary to satisfy the following condition:

D·t≦λ·15 μm·(1.585−1.45)²/(nᵤ−nₚ)² (17)

where (nᵤ−nₚ)² is a value when one of (n_{LC}′−nₚ)² and (nₒ′−nₚ)² is larger than the other.

In order to largely change the focal length of the variable focal-length lens 511, it is favorable that the ratio ff is as high as possible, but in the case of ff=1, the volume of the macromolecule becomes zero and the macromolecular cells 518 cease to be formable. Thus, it is necessary to satisfy the following condition:

0.1≦ff≦0.999 (18)

On the other hand, the transmittance T improves as the ratio ff becomes low, and hence Condition (17) may be moderated, preferably, as follows:

4×10⁻⁶[μm]²≦D·t≦π·45 μm·(1.585−1.45)²/(nᵤ−nₚ)² (19)

Also, the lower limit of the thickness t, as is obvious from FIG. 30, corresponds to the diameter D, which is at least 2 nm as described above, and therefore the lower limit of D·t becomes (2×10⁻³ μm)², namely 4×10⁻⁶ [μm]².

An approximation where the optical property of substance is represented by the refractive index is established when the diameter D is 5-10 nm or larger, as set forth in “Iwanami Science Library 8, Asteroids are coming”, T. Mukai, Iwanami Shoten, p. 58, 1994. If the value of the diameter D exceeds 500 λ, the scattering of light will be changed geometrically, and the scattering of light at the interfaces between the macromolecules and the liquid crystal molecules 517 constituting the macromolecular cells 518 is increased in accordance with the Fresnel's equation of reflection. As such, in practical use, the diameter D must be chosen so as to satisfy the following condition:

7 nm≦D≦500λ (20)

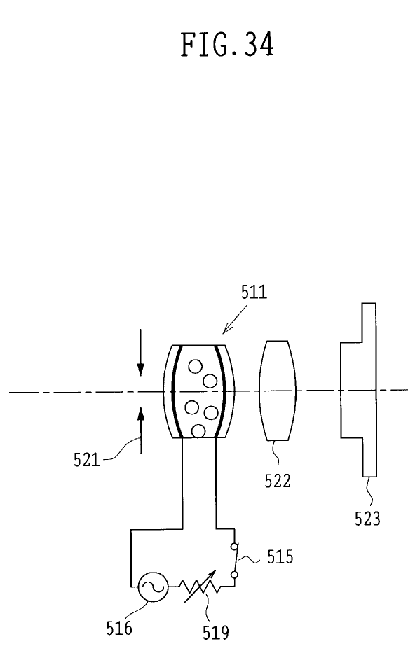

FIG. 34 shows an imaging optical system for digital cameras using the variable focal-length lens 511 of FIG. 33. In this imaging optical system, an image of an object (not shown) is formed on the solid-state image sensor 523, such as a CCD, through a stop 521, the variable focal-length lens 511, and a lens 522. Also, in FIG. 34, the liquid crystal molecules are not shown.

According to such an imaging optical system, the alternating voltage applied to the macromolecular dispersed liquid crystal layer 514 of the variable focal-length lens 511 is controlled by the variable resistor 519 to change the focal length of the variable focal-length lens 511. Whereby, without moving the variable focal-length lens 511 and the lens 522 along the optical axis, it becomes possible to perform continuous focusing with respect to the object distance, for example, from the infinity to 600 mm.

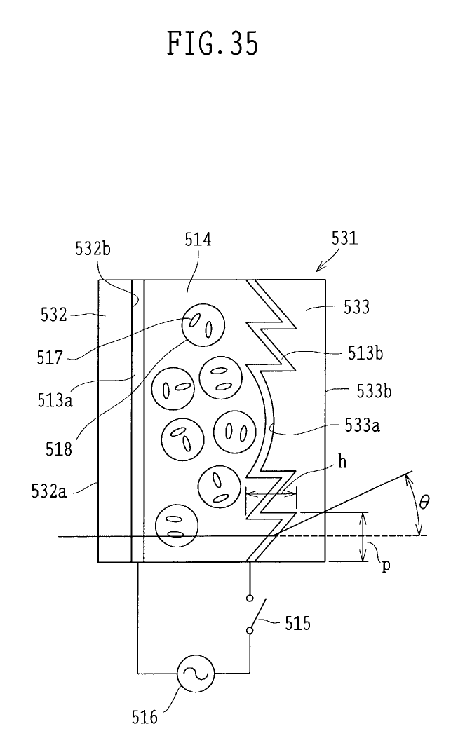

FIG. 35 shows one example of a variable focal-length diffraction optical element applicable to the camera of the present invention. This variable focal-length diffraction optical element 531 includes a first transparent substrate 532 having a first surface 532a and a second surface 532b which are parallel with each other and a second transparent substrate 533 having a third surface 533a which is constructed with an annular diffraction grating of saw-like cross section having the depth of a groove corresponding to the wavelength of light and a fourth surface 533b which is flat. Incident light emerges through the first and second transparent substrates 532 and 533. Between the first and second transparent substrates 532 and 533, as in FIG. 30, the macromolecular dispersed liquid crystal layer 514 is sandwiched through the transparent electrodes 513a and 513b so that the transparent electrodes 513a and 513b are connected to the alternating-current power supply 516 through the switch 515 and the alternating-current electric field is applied to the macromolecular dispersed liquid crystal layer 514.

In such a structure, when the grating pitch of the third surface 533a is represented by p and an integer is represented by m, a ray of light incident on the variable focal-length diffraction optical element 531 is deflected by an angle θ satisfying the following equation:

p sin θ=mλ (21)

and emerges therefrom. When the depth of the groove is denoted by h, the refractive index of the transparent substrate 533 is denoted by n₃₃, and an integer is denoted by k, a diffraction efficiency becomes 100% at the wavelength λ and the production of flare can be prevented by satisfying the following equations:

h(n_{A}−n₃₃)=mλ (22)

h(n_{B}−n₃₃)=kλ (23)

Here, the difference in both sides between Equations (22) and (23) is given by

h(n_{A}−n_{B})=(m−k)λ (24)

Therefore, when it is assumed that λ=500 nm, n_{A}=1.55, and n_{B}=1.5,

0.05 h=(m−k)·500 nm

and when m=1 and k=0,

h=10000 nm=10 μm

In this case, the refractive index n₃₃ of the transparent substrate 533 is obtained as 1.5 from Equation (22). When the grating pitch p on the periphery of the variable focal-length diffraction optical element 531 is assumed to be 10 μm, θ≈2.87° and a lens with an F-number of 10 can be obtained.

The variable focal-length diffraction optical element 531, whose optical path length is changed by the on-off operation of the voltage applied to the liquid crystal layer 514, for example, can be used for focus adjustment in such a way that it is placed at a portion where the light beam of a lens system is not parallel, or can be used to change the focal length of the entire lens system.

In the embodiment, it is only necessary that Equations (22)-(24) are set in practical use to satisfy the following conditions:

0.7 mλ≦h(n_{A}−n₃₃)≦1.4 mλ (25)

0.7 kλ≦h(n_{A}−n₃₃)≦1.4 kλ (26)

0.7(m−k)λ≦h(n_{A}−n_{B})≦1.4(m−k)λ (27)

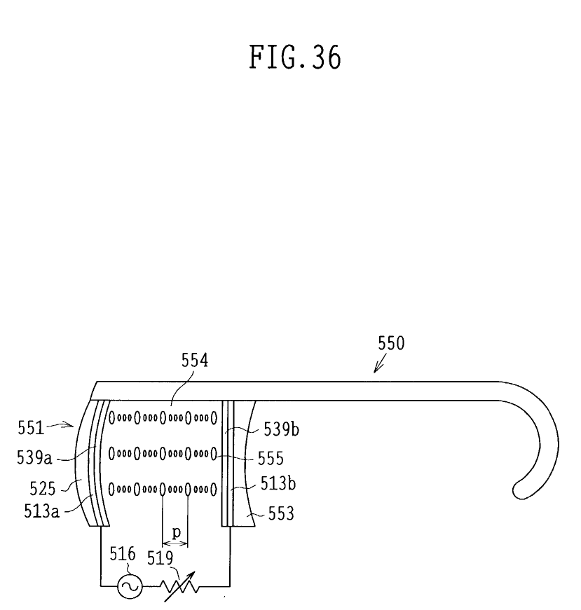

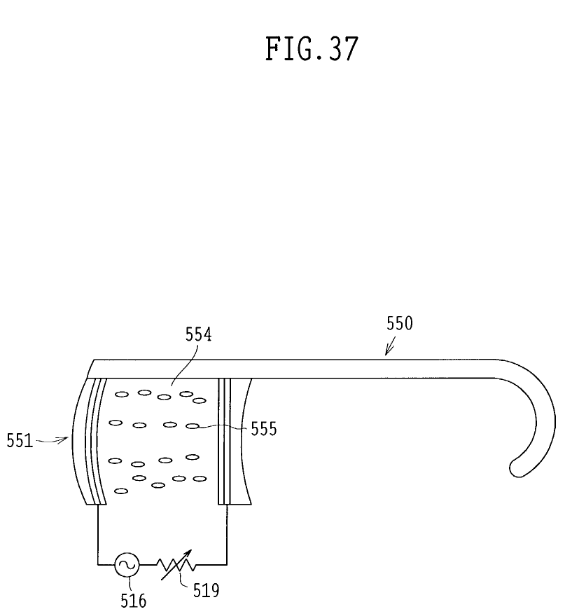

A variable focal-length lens using a twisted nematic liquid crystal also falls into the category of the present invention. FIGS. 36 and 37 show variable focal-length spectacles 550 in this case. The variable focal-length lens 551 has lenses 552 and 553, orientation films 539a and 539b provided through the transparent electrodes 513a and 513b, respectively, inside these lenses, and a twisted nematic liquid crystal layer 554 sandwiched between the orientation films. The transparent electrodes 513a and 513b are connected to the alternating-current power supply 516 through the variable resistor 519 so that the alternating-current electric field is applied to the twisted nematic liquid crystal layer 554.

In this structure, when the voltage applied to the twisted nematic liquid crystal layer 554 is increased, liquid crystal molecules 555, as illustrated in FIG. 37, exhibit a homeotropic orientation, in which the refractive index of the liquid crystal layer 554 is lower and the focal length is longer than in a twisted nematic condition of FIG. 36 in which the applied voltage is low.

A spiral pitch P of the liquid crystal molecules 555 in the twisted nematic condition of FIG. 36 must be made nearly equal to, or much smaller than, the wavelength λ of light, and thus is set to satisfy the following condition:

2 nm≦P≦2λ/3 (28)

Also, the lower limit of this condition depends on the sizes of the liquid crystal molecules, while the upper limit is necessary for the behavior of the liquid crystal layer 554 as an isotropic medium under the condition of FIG. 36 when incident light is natural light. If the upper limit of the condition is overstepped, the variable focal-length lens 551 is changed to a lens in which the focal length varies with the direction of deflection. Hence, a double image is formed and only a blurred image is obtained.

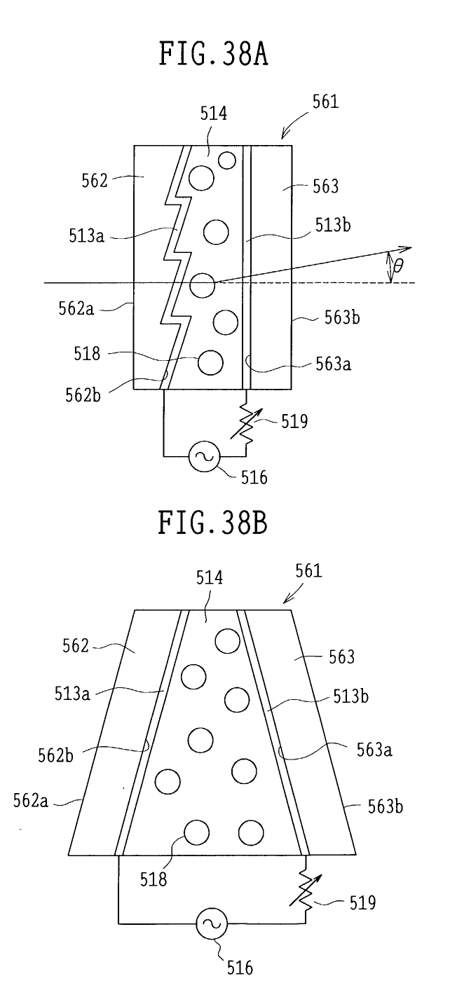

FIG. 38A shows a variable deflection-angle prism applicable to the camera of the present invention. A variable deflection-angle prism 561 includes a first transparent substrate 562 on the entrance side, having a first surface 562a and a second surface 562b; and a second transparent substrate 563 of a plane-parallel plate on the exit side, having a third surface 563a and a fourth surface 563b. The inner surface (the second surface) 562b of the transparent substrate 562 on the entrance side is configured into a Fresnel form, and the macromolecular dispersed liquid crystal layer 514, as in FIG. 30, is sandwiched, through the transparent electrodes 513a and 513b, between the transparent substrate 562 and the transparent substrate 563 on the exit side. The transparent electrodes 513a and 513b are connected to the alternating-current power supply 516 through the variable resistor 519. Whereby, the alternating-current electric field is applied to the liquid crystal layer 514 so that the deflection angle of light transmitted through the variable deflection-angle prism 561 is controlled. Also, in FIG. 38A, the inner surface 562b of the transparent substrate 562 is configured into the Fresnel form, but as shown in FIG. 38B, the inner surfaces of the transparent substrates 562 and 563 may be configured like an ordinary prism whose surfaces are relatively inclined, or may be configured like the diffraction grating shown in FIG. 35. In the case of the latter, when Equations (21)-(24) and Conditions (25)-(27) are satisfied, the same description as in the variable focal-length diffraction optical element 531 and the variable focal-length spectacles 550 is applied.

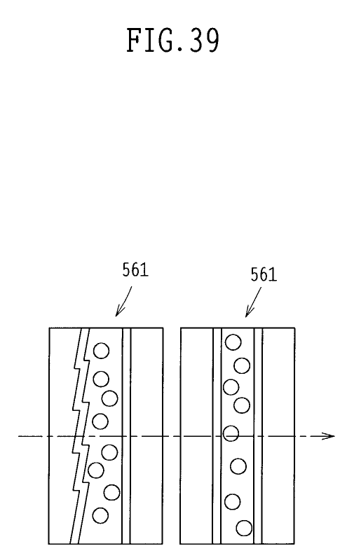

The variable deflection-angle prism 561 constructed mentioned above can be effectively used for shake prevention for TV cameras, digital cameras, film cameras, binoculars, etc. In this case, it is desirable that the direction of refraction (deflection) of the variable deflection-angle prism 561 is vertical, but in order to further improve its performance, it is desirable that two variable deflection-angle prisms 561 are arranged so that the directions of deflection are varied and as shown in FIG. 39, the refraction angles are changed in vertical and lateral directions. Also, in FIGS. 38A, 38B, and 39, the liquid crystal molecules are omitted.

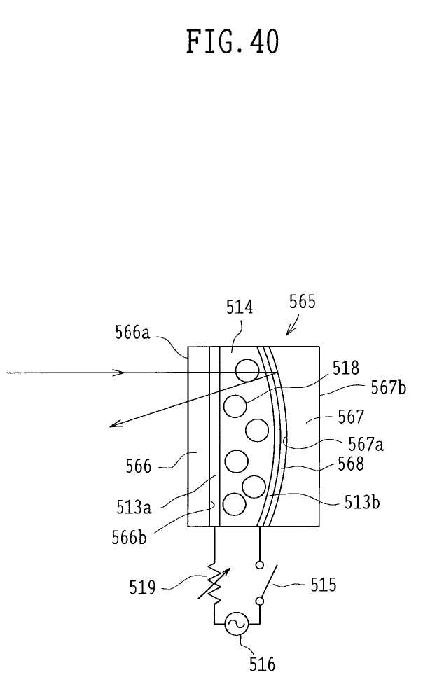

FIG. 40 shows a variable focal-length mirror as the variable focal-length lens applicable to the present invention. A variable focal-length mirror 565 includes a first transparent substrate 566 having a first surface 566a and a second surface 566b, and a second transparent substrate 567 having a third surface 567a and a fourth surface 567b. The first transparent substrate 566 is configured into a flat plate or lens shape to provide the transparent electrode 513a on the inner surface (the second surface) 566b. The second transparent substrate 567 is such that the inner surface (the third surface) 567a is configured as a concave surface, on which a reflecting film 568 is deposited, and the transparent electrode 513b is provided on the reflecting film 568. Between the transparent electrodes 513a and 513b, as in FIG. 30, the macromolecular dispersed liquid crystal layer 514 is sandwiched so that the transparent electrodes 513a and 513b are connected to the alternating-current power supply 516 through the switch 515 and the variable resistor 519, and the alternating-current electric field is applied to the macromolecular dispersed liquid crystal layer 514. Also, in FIG. 40, the liquid crystal molecules are omitted.

According to the above structure, since a ray of light incident on the transparent substrate 566 is passed again through the liquid crystal layer 514 by the reflecting film 568, the function of the liquid crystal layer 514 can be exercised twice, and the focal position of reflected light can be shifted by changing the voltage applied to the liquid crystal layer 514. In this case, the ray of light incident on the variable focal-length mirror 565 is transmitted twice through the liquid crystal layer 514, and therefore when a thickness twice that of the liquid crystal layer 514 is represented by t, Conditions mentioned above can be used. Moreover, the inner surface of the transparent substrate 566 or 567, as shown in FIG. 35, can also be configured into the diffraction grating shape to reduce the thickness of the liquid crystal layer 514. By doing so, the amount of scattered light can be decreased.

In the above description, in order to prevent the deterioration of the liquid crystal, the alternating-current power supply 516 is used as a voltage source to apply the alternating-current electric field to the liquid crystal. However, a direct-current power supply is used and thereby a direct-current electric field can also be applied to the liquid crystal. Techniques of shifting the orientation of the liquid crystal molecules, in addition to changing the voltage, can be achieved by changing the frequency of the electric field applied to the liquid crystal, the strength and frequency of the magnetic field applied to the liquid crystal, or the temperature of the liquid crystal. In the above embodiments, since the macromolecular dispersed liquid crystal is close to a solid, rather than a liquid, one of the lenses 512a and 512b, the transparent substrate 532, the lens 522, one of the lenses 552 and 553, the transparent substrate 563 of FIG. 38A, or one of the transparent substrates 562 and 563 of FIG. 38B, may be eliminated.

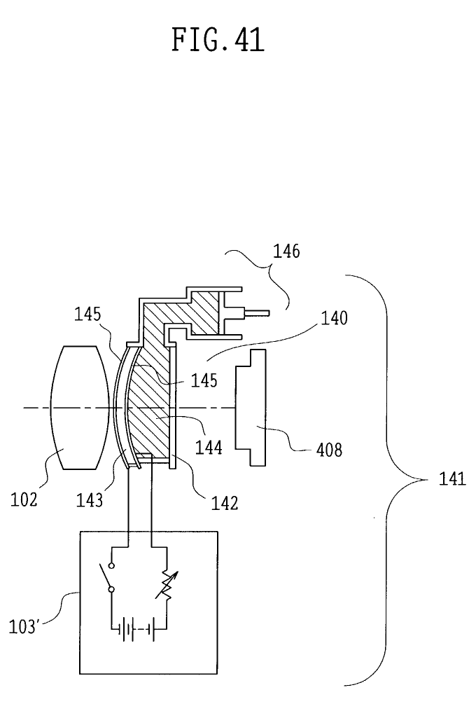

FIG. 41 shows an imaging unit 141 using a variable focal-length lens 140, in another embodiment, applicable to the camera of the present invention. The imaging unit 141 can be used as the imaging system of the present invention. In this embodiment, the lens 102 and the variable focal-length lens 140 constitute an imaging lens system, and the imaging lens system and the solid-state image sensor 408 constitute the imaging unit 141. The variable focal-length lens 140 is constructed with a light-transmitting fluid or jelly-like substance 144 sandwiched between a transparent member 142 and a soft transparent substance 143 such as piezoelectric synthetic resin.

As the fluid or jelly-like substance 144, silicon oil, elastic rubber, jelly, or water can be used. Transparent electrodes 145 are provided on both surfaces of the transparent substance 143, and when the voltage is applied through a circuit 103′, the transparent substance 143 is deformed by the piezoelectric effect of the transparent substance 143 so that the focal length of the variable focal-length lens 140 is changed.

Thus, according to the embodiment, even when the object distance is changed, focusing can be performed without moving the optical system with a motor, and as such the embodiment excels in compact and lightweight design and low power consumption.

In FIG. 41, reference numeral 146 denotes a cylinder for storing a fluid. For the transparent substance 143, high-polymer piezoelectrics such as polyurethane, silicon rubber, acrylic elastomer, PZT, PLZT, and PVDF; vinylidene cyanide copolymer; or copolymer of vinylidene fluoride and trifluoroethylene is used.

The use of an organic substance, synthetic resin, or elastomer, having a piezoelectric property, brings about a considerable deformation of the surface of the deformable mirror, which is favorable. It is good practice to use a transparent piezoelectric substance for the variable focal-length lens.

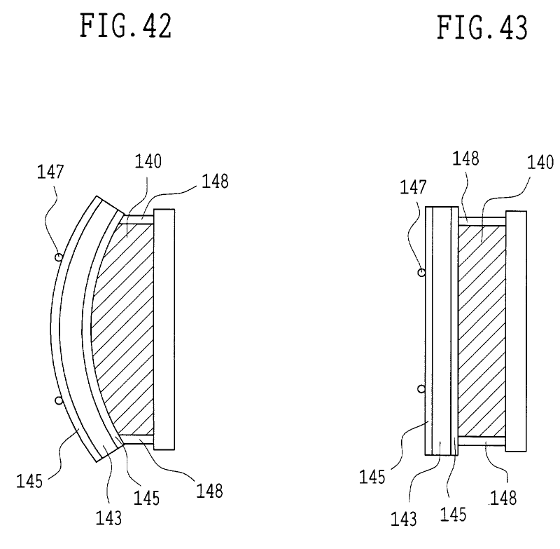

In FIG. 41, instead of using the cylinder 146, the variable focal-length lens 140, as shown in FIG. 42, may be designed to use supporting members 147.

The supporting members 147 are designed to fix the periphery of a part of the transparent substance 143 sandwiched between the transparent electrodes 145. According to the embodiment, even when the voltage is applied to the transparent substance 143 and thereby the transparent substance 143 is deformed, as shown in FIG. 43, the volume of the entire variable focal-length lens 140 remains unchanged. As such, the cylinder 146 becomes unnecessary. Also, in FIGS. 42 and 43, reference numeral 148 designates a deformable member, which is made with an elastic body, accordion-shaped synthetic resin, or metal.

In each of the examples shown in FIGS. 41 and 42, when a reverse voltage is applied, the transparent substance 143 is deformed in a reverse direction, and thus it is also possible to construct a concave lens.

Where an electrostrictive substance, for example, acrylic elastomer or silicon rubber, is used for the transparent substance 143, it is desirable that the transparent substance 143 is constructed so that the transparent substrate and the electrostrictive substance are cemented to each other.

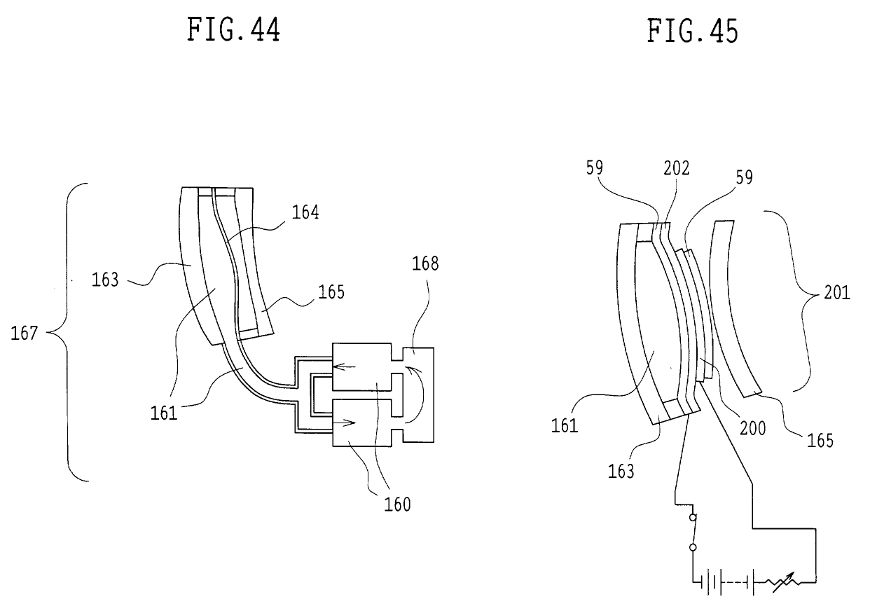

FIG. 44 shows a variable focal-length lens 167 in which the fluid 161 is taken in and out by a micropump 160 to deform the lens surface, in another embodiment of the variable focal-length lens applicable to the camera of the present invention.

The micropump 160 is a small-sized pump, for example, made by a micromachining technique and is constructed so that it is operated with an electric power. The fluid 161 is sandwiched between a transparent substrate 163 and an elastic body 164. In FIG. 44, reference numeral 165 represents a transparent substrate for protecting the elastic body 164 and this substrate is not necessarily required.

As examples of pumps made by the micromachining technique, there are those which use thermal deformations, piezoelectric substances, and electrostatic forces.

It is also possible to use the micropump 180 shown in FIG. 29 as two micropumps, for example, as in the micropump 160 used in the variable focal-length lens 167 of FIG. 44.

In the variable focal-length lens which uses the electrostatic force or the piezoelectric effect, a high voltage is sometimes required for drive. In this case, it is desirable that the boosting transformer or the piezoelectric transformer is used to constitute the control system. When a laminated piezoelectric transformer is particularly used, a compact design is achieved.

FIG. 45 shows a variable focal-length lens 201 using a piezoelectric substance 200 in another embodiment of a variable optical-property element applicable to the camera of the present invention.

The same substance as the transparent substance 143 is used for the piezoelectric substance 200, which is provided on a soft transparent substrate 202. It is desirable that synthetic resin or an organic substance is used for the substrate 202.

In this embodiment, the voltage is applied to the piezoelectric substance 200 through the two transparent electrodes 59, and thereby the piezoelectric substance 200 is deformed so that the function of a convex lens is exercised in FIG. 45.

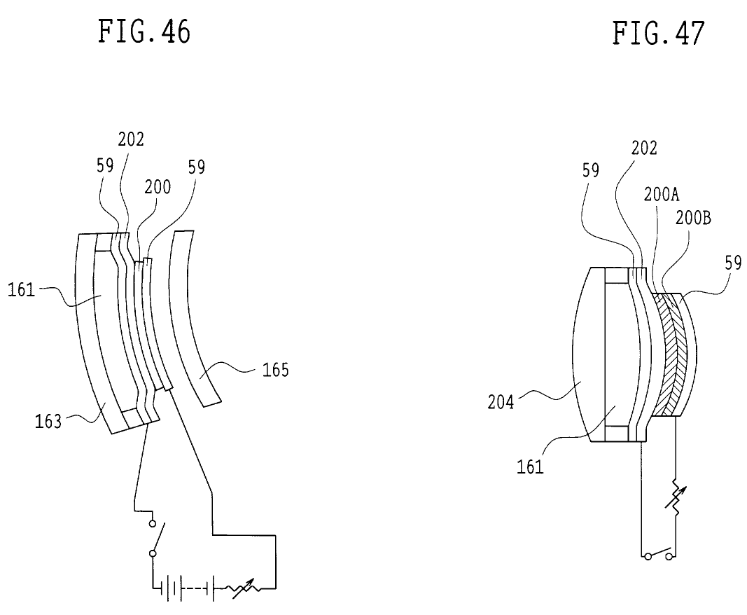

The substrate 202 is previously configured into a convex form, and at least one of the two transparent electrodes 59 is caused to differ in size from the substrate 202, for example, one of the electrodes 59 is made smaller than the substrate 202. In doing so, when the applied voltage is removed, the opposite, preset portions of the two transparent electrodes 59, as shown in FIG. 46, are deformed into concave shapes so as to have the function of a concave lens, acting as the variable focal-length lens.

In this case, since the substrate 202 is deformed so that the volume of the fluid 161 is not changed, there is the merit that the liquid tank 168 becomes unnecessary.

This embodiment has a great merit that a part of the substrate holding the fluid 161 is deformed by the piezoelectric substance and the liquid tank 168 is dispensed with.

The transparent substrates 163 and 165 may be constructed with lenses or plane surfaces, and the same may be said of the embodiment of FIG. 44.

FIG. 47 shows a variable focal-length lens using two thin plates 200A and 200B constructed of piezoelectric substances in still another embodiment of the variable optical-property element applicable to the camera of the present invention.

The variable focal-length lens of this embodiment has the merit that the thin plate 200A is reversed in direction of the substance with respect to the thin plate 200B, and thereby the amount of deformation is increased so that a wide variable focal-length range can be obtained. Also, in FIG. 47, reference numeral 204 denotes a lens-shaped transparent substrate. Even in the embodiment, the transparent electrode 59 on the right side of the figure is configured to be smaller than the substrate 202.

In the embodiments of FIGS. 45-47, the thicknesses of the substrate 202, the piezoelectric substance 200, and the thin plates 200A and 200B may be rendered uneven so that a state of deformation caused by the application of the voltage is controlled. By doing so, lens aberration can be corrected, which is convenient.

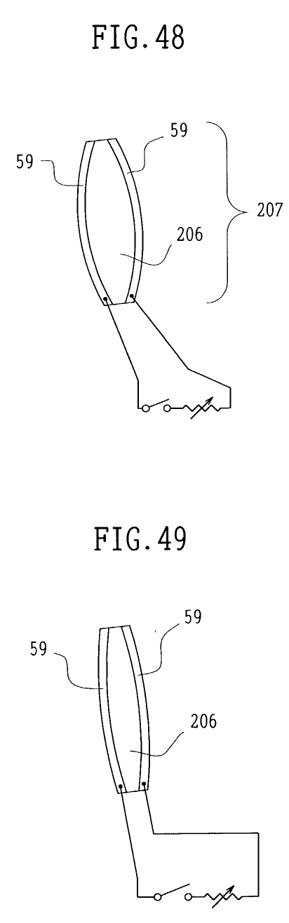

FIG. 48 shows another embodiment of the variable focal-length lens applicable to the present invention. A variable focal-length lens 207 of this embodiment uses an electrostrictive substance 206 such as silicon rubber or acrylic elastomer.

According to the embodiment, when the voltage is low, the electrostrictive substance 206, as depicted in FIG. 48, acts as a convex lens, while when the voltage is increased, the electrostrictive substance 206, as depicted in FIG. 49, expands in a vertical direction and contracts in a lateral direction, and thus the focal length is increased. In this way, the electrostrictive substance 206 operates as the variable focal-length lens. According to the variable focal-length lens of the embodiment, there is the merit that since a large power supply is not required, power consumption is minimized.

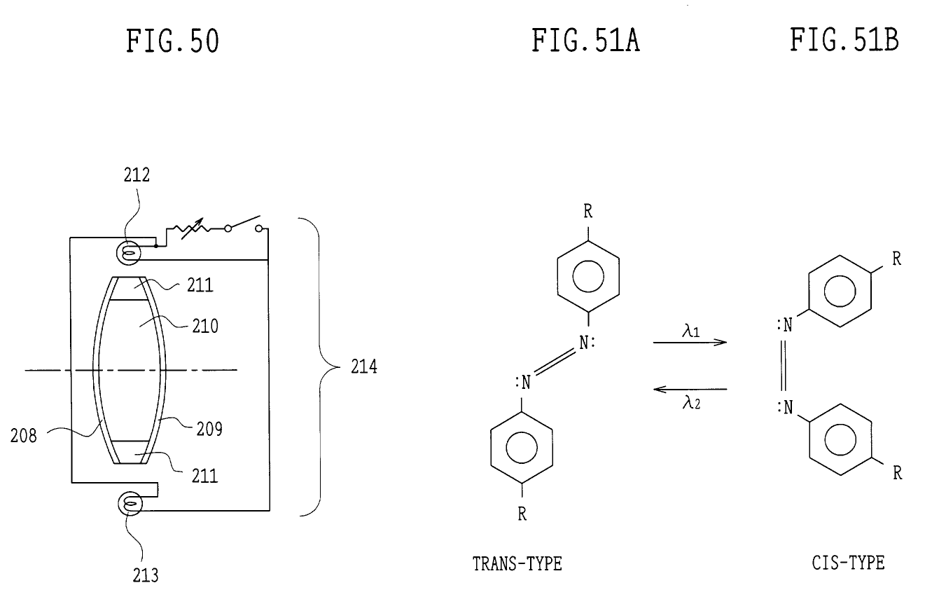

FIG. 50 shows a variable focal-length lens using a photonical effect in a further embodiment of the variable optical-property element applicable to the camera of the present invention. A variable focal-length lens 214 of this embodiment is designed so that azobenzene 210 is sandwiched between transparent elastic bodies 208 and 209 and is irradiated with ultraviolet light through a transparent spacer 211. In FIG. 50, reference numerals 212 and 213 represent ultraviolet light sources, such as ultraviolet LEDs or ultraviolet semiconductor lasers, of central wavelengths λ₁ and λ₂, respectively.

In the embodiment, when trans-type azobenzene shown in FIG. 51A is irradiated with ultraviolet light of the central wavelength λ₁, the azobenzene 210 changes to cis-type azobenzene shown in FIG. 51B to reduce its volume. Consequently, the thickness of the variable focal-length lens 214 is decreased, and the function of the convex lens is impaired.

On the other hand, when the cis-type azobenzene is irradiated with ultraviolet light of the central wavelength λ₂, the azobenzene 210 changes to the trans-type azobenzene to increase the volume. Consequently, the thickness of the variable focal-length lens 214 is increased, and the function of the convex lens is improved.

In this way, the optical element of the embodiment acts as the variable focal-length lens. In the variable focal-length lens 214, since the ultraviolet light is totally reflected at the interface between each of the transparent elastic bodies 208 and 209 and air, the light does not leak through the exterior and high efficiency is obtained.

In the variable focal-length lens of each of the embodiments mentioned above, each of the transparent electrodes 145, 59, 508a, 509a, 513a, and 513b may be divided into a plurality of segments. By applying different voltages to individual divided transparent electrodes, it becomes possible to carry out not only the focusing, zoom, and magnification change of the optical apparatus, but also shake compensation, compensation for degradation of optical performance by manufacturing errors, and correction for aberration.

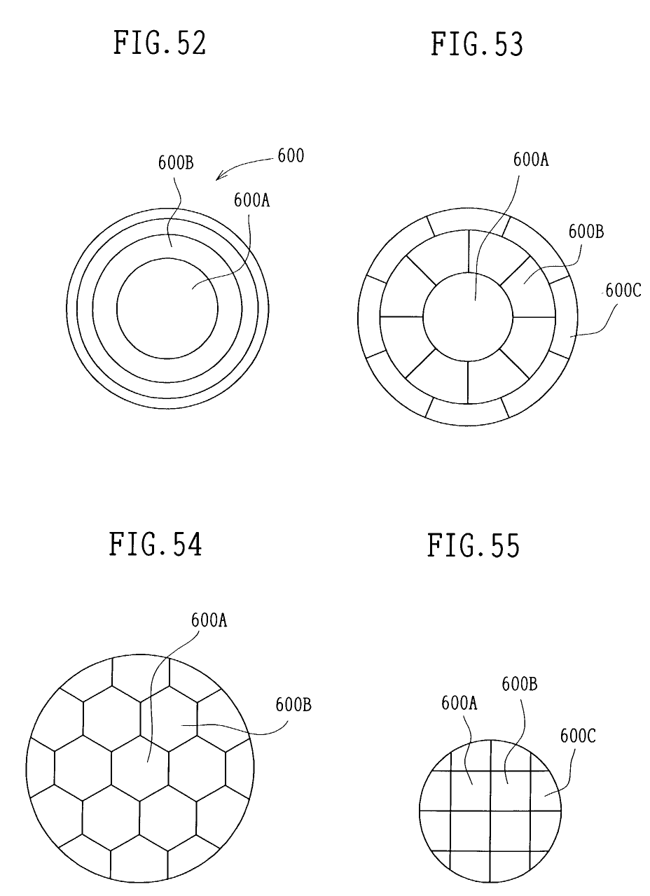

Subsequently, a description will be given of examples of various division patterns of the transparent electrode used in the variable focal-length lens applicable to the camera of the present invention, with reference to FIGS. 52-55.

FIG. 52 shows an example where a transparent electrode 600 is concentrically divided. A zone narrows progressively in going from the center to the periphery. It is for this reason that correction for aberration is facilitated.

In FIG. 53, each zone is further divided so that three boundaries of the electrodes are converged. By doing so, the shape of the piezoelectric substance 200 is smoothly changed, and hence a lens with less aberration is obtained.

In FIG. 54, the transparent electrode 600 is divided into hexagons so that, for the same reason as in the above description, three boundaries of the electrodes are converged.

It is advantageous for correction for aberration that individual divided electrodes 600A, 600B, 600C, . . . in FIGS. 53 and 54 have almost the same area. Thus, it is desirable that an area ratio of an electrode with the largest area to an electrode with the smallest area, of the divided electrodes, is set within 100:1.

The divided electrodes, as in FIGS. 52-54, are arrayed so that the central electrode 600A is surrounded by others. In a circular lens, this is particularly advantageous for correction for aberration. The boundaries of the transparent electrodes which are converged may be set so that mutual angles are larger than 90°. Also, as shown in FIG. 55, the electrode may be divided into lattice-like segments. Such a division pattern has the merit that fabrication is easy.

In order to completely correct aberration or the shake of the optical system, it is desirable that the number of divided electrodes is as large as possible. At least 7 divided electrodes are required to correct second-order aberration; at least 9 divided electrodes to correct third-order aberration; at least 13 divided electrodes to correct fourth-order aberration; at least 16 divided electrodes to correct fifth-order aberration; and at least 25 divided electrodes to correct seventh-order aberration. Also, the second-order aberration refers to components in the x and y directions of tilt, astigmatism, and coma. However, if at least 3 divided electrodes are available for a low-cost product, considerable aberration or a sharp shake can be corrected.

Finally, the definitions of terms employed in the present invention will be described.

An optical apparatus used in the present invention refers to an apparatus including an optical system or optical elements. The optical apparatus need not necessarily function by itself. That is, it may be thought of as a part of an apparatus. The optical apparatus includes an imaging device, an observation device, a display device, an illumination device, and a signal processing device.

The imaging device refers to, for example, a film camera, a digital camera, a robot's eye, a lens-exchangeable digital single-lens reflex camera, a TV camera, a moving-picture recorder, an electronic moving-picture recorder, a camcorder, a VTR camera, or an electronic endoscope. Any of the digital camera, a card digital camera, the TV camera, the VTR camera, and a moving-picture recording camera is an example of an electronic imaging device.

The observation device refers to, for example, a microscope, a telescope, spectacles, binoculars, a magnifier, a fiber scope, a finder, or a viewfinder.

The display device includes, for example, a liquid crystal display, a viewfinder, a game machine (Play Station by Sony), a video projector, a liquid crystal projector, a head mounted display (HMD), a personal digital assistant (PDA), or a cellular phone.

The illumination device includes, for example, a stroboscopic lamp for cameras, a headlight for cars, a light source for endoscopes, or a light source for microscopes.

The signal processing device refers to, for example, a cellular phone, a personal computer, a game machine, a read/write device for optical disks, or an arithmetic unit for optical computers.

The image sensor refers to, for example, a CCD, a pickup tube, a solid-state image sensor, or a photographing film. The plane-parallel plate is included in one of prisms. A change of an observer includes a change in diopter. A change of an object includes a change in object distance, the displacement of the object, the movement of the object, vibration, or the shake of the object.

The extended surface is defined as follows:

Each of the surfaces of lenses, prisms, and mirrors need not necessarily be planar, and may have any shape such as a spherical or rotationally symmetrical aspherical surface; a spherical, planar, or rotationally symmetrical aspherical surface which is decentered with respect to the optical axis; an aspherical surface with symmetrical surfaces; an aspherical surface with only one symmetrical surface; an aspherical surface with no symmetrical surface; a free-formed surface; a surface with a nondifferentiable point or line; etc. Moreover, any surface which has some effect on light, such as a reflecting or refracting surface, is satisfactory. In the present invention, it is assumed that such a surface is generally referred as to the extended surface.

The variable optical-property element includes a variable focal-length lens, a deformable mirror, a deflection prism whose surface profile is changed, a variable angle prism, a variable diffraction optical element in which the function of light deflection is changed, namely a variable HOE, or a variable DOE.

The variable focal-length lens also includes a variable lens such that the focal length is not changed, but the amount of aberration is changed. The same holds for the case of the deformable mirror. In a word, an optical element in which the function of light deflection, such as reflection, refraction, or diffraction, can be changed is called the variable optical-property element.

An information transmitter refers to a device which is capable of inputting and transmitting any information from a cellular phone; a stationary phone; a remote control for game machines, TVs, radio-cassette tape recorders, or stereo sound systems; a personal computer; or a keyboard, mouse, or touch panel for personal computers. It also includes a TV monitor with the imaging device, or a monitor or display for personal computers. The information transmitter is included in the signal processing device.

What is claimed is:

1. An optical apparatus using a deformable mirror, said optical apparatus comprising:
imaging means for obtaining an image signal from an image formed through a photographic lens;
exposure control means for making control containing driving control of said imaging means;
a deformable mirror having a reflecting surface deformed by an electric force and electrodes controlling a profile of said reflecting surface;
power supply means for supplying power to drive said deformable mirror;
driving means for driving said deformable mirror; and
means for driving said photographic lens,
wherein when said photographic lens is driven and when exposure is controlled by said exposure control means, said deformable mirror is free from driving by said driving means.

2. An optical apparatus using a deformable mirror according to claim 1, further comprising stroboscope control means for controlling a charge and discharge of a stroboscope illuminating an object so that when said charge and discharge of said stroboscope is controlled, said deformable mirror is free from driving by said driving means.

3. An optical apparatus using a deformable mirror according to claim 1, further comprising recording means for recording data according to an image signal obtained by said imaging means so that when said data are recorded by said recording means, said deformable mirror is free from driving by said driving means.

4. An optical apparatus using a deformable mirror according to claim 1, further comprising mode setting means for setting a plurality of modes containing a photographic mode so that when a mode other than said photographic mode is set by said mode setting means, said deformable mirror is free from driving by said driving means.

5. An optical apparatus using a deformable mirror, said optical apparatus comprising:
imaging means for obtaining an image signal from an image formed through a photographic lens;
exposure control means for making control containing driving control of said imaging means through an exposure operation according to a photographing condition;
a deformable mirror having a reflecting surface deformed by electrostatic attraction and electrodes controlling a profile of said reflecting surface;
power supply means for supplying power to drive said deformable mirror;
driving means for driving said deformable mirror; and
means for driving said photographic lens,
wherein when said photographic lens is driven and when exposure is controlled by said exposure control means, said deformable mirror is free from driving by said driving means.

6. An optical apparatus using a deformable mirror, said optical apparatus comprising:
imaging means for obtaining an image signal from an image formed through a photographic lens;
exposure control means for making control containing driving control of said imaging means through an exposure operation according to a photographing condition;
a deformable mirror having a reflecting surface deformed by an electromagnetic force and electrodes controlling a profile of said reflecting surface;
power supply means for supplying power to drive said deformable mirror;
driving means for driving said deformable mirror; and
means for driving said photographic lens,
wherein when said photographic lens is driven and when exposure is controlled by said exposure control means, said deformable mirror is free from driving by said driving means.

7. An optical apparatus using a deformable mirror, said optical apparatus comprising:
imaging means for obtaining an image signal from an image formed through a photographic lens;
exposure control means for making control containing driving control of said imaging means through an exposure operation according to a photographing condition;
a deformable mirror having a reflecting surface deformed by a piezoelectric effect and electrodes controlling a profile of said reflecting surface;
power supply means for supplying power to drive said deformable mirror;
driving means for driving said deformable mirror; and
means for driving said photographic lens,
wherein when said photographic lens is driven and when exposure is controlled by said exposure control means, said deformable mirror is free from driving by said driving means.

8. An optical apparatus using a deformable mirror according to any one of claims 1-7, wherein said deformable mirror is placed in an optical path in which light for range measurement of a range measurement section measuring a distance of an object is projected.

9. An optical apparatus using a deformable mirror according to any one of claims 1-7, wherein said deformable mirror is placed in a photographic lens system including said photographic lens.

10. An optical apparatus using a deformable mirror according to claim 9, wherein during a range measurement process at a range measurement section measuring a distance of an object, said deformable mirror is free from a supply of power by said power supply means and from driving by said driving means.

11. A driving device of a deformable mirror, said driving device comprising:
a deformable mirror having a reflecting surface and electrodes controlling a profile of said reflecting surface;
driving means for driving said deformable mirror;
memory means for prestoring data according to a change of the profile of said reflecting surface; and
correcting means for correcting a driving condition of said driving means in accordance with said data stored in said memory means.

12. A driving device of a deformable mirror according to claim 11, wherein said memory means stores data for obtaining a desired profile of said reflecting surface in an initial state through said driving means.

13. A driving means of a deformable mirror according to claim 11, wherein said driving means drives said electrodes into an initial state in accordance with said data stored in said memory means when a power source is turned on or before photographing.

14. A driving means of a deformable mirror according to claim 11, wherein said deformable mirror further has a monitor output means for monitoring a driving state of said electrodes.
